(19) United States
(12) Patent Application Publication
(10) Pub. No.: US 2025/0350139 A1
(43) Pub. Date: Nov. 13, 2025

(54) VOLTAGE REGULATING DEVICE AND CHARGE STORAGE SYSTEM

(71) Applicant: ROHM CO., LTD., Kyoto (JP)

(72) Inventors: Hiroki KIKUCHI, Kyoto (JP); Satoshi MAEJIMA, Kyoto (JP)

(21) Appl. No.: 19/199,868

(22) Filed: May 6, 2025

(30) Foreign Application Priority Data
May 13, 2024 (JP) 2024-078018

(51) Int. Cl. H02J 7/00; H02M 3/158

(52) U.S. Cl. CPC H02J 7/00712; H02M 3/1584; H02J 2207/20; H02J 2207/50

(57) ABSTRACT

A voltage regulating device connected to a series circuit of electrolytic capacitors provided between a ground wiring and an input voltage wiring, includes: a high-side terminal connected to the input voltage wiring; a low-side terminal connected to the ground wiring; a middle terminal connected to a connection node between the electrolytic capacitors; and a voltage limiting circuit configured to limit a voltage between the high-side terminal and the middle terminal to a high-side limit voltage or lower by controlling a high-side regulating current between the high-side terminal and the middle terminal according to the voltage between the high-side terminal and the middle terminal, and configured to limit a voltage between the middle terminal and the low-side terminal to a low-side limit voltage or lower by controlling a low-side regulating current between the middle terminal and the low-side terminal according to the voltage between the middle terminal and the low-side terminal.

### CROSS-REFERENCE TO RELATED APPLICATION

The present invention claims priority under 35 U.S.C. § 119 to Japanese Patent Application No. 2024-078018, filed on May 13, 2024, the entire contents of which are incorporated herein by reference.

### TECHNICAL FIELD

The present disclosure relates to a voltage regulating device and a charge storage system.

### BACKGROUND

In cases where a single electrolytic capacitor does not have a sufficient breakdown voltage, a plurality of electrolytic capacitors connected in series may be used.

### BRIEF DESCRIPTION OF DRAWINGS

The accompanying drawings, which are incorporated in and constitute a part of the specification, illustrate embodiments of the present disclosure.

FIG. 1 is an overall configuration diagram of a circuit system according to an embodiment of the present disclosure.

FIG. 2 is a diagram showing a configuration example of a voltage supply device according to an embodiment of the present disclosure.

FIG. 3 is a diagram showing another configuration example of the voltage supply device according to an embodiment of the present disclosure.

FIG. 4 is a diagram showing configurations and connection relationships of a capacitance device and a voltage regulating device according to an embodiment of the present disclosure.

FIG. 5 is a diagram for explaining a reference configuration, and shows a state in which voltages applied to two capacitors connected in series become unequal.

FIG. 6 is a diagram showing a reference configuration.

FIG. 7 is a circuit diagram of a voltage regulating device according to Example EX_A1 belonging to an embodiment of the present disclosure.

FIG. 8 is a waveform diagram for explaining an operation of the voltage regulating device according to Example EX_A1 belonging to the embodiment of the present disclosure.

FIG. 9 is a waveform diagram for explaining an operation of the voltage regulating device according to Example EX_A1 belonging to the embodiment of the present disclosure.

FIG. 10 is a waveform diagram for explaining an operation of the voltage regulating device according to Example EX_A1 belonging to the embodiment of the present disclosure.

FIG. 11 is an external plan view of a semiconductor device according to Example EX_A2 belonging to the embodiment of the present disclosure.

FIG. 12 is a diagram for explaining a relationship between a voltage regulating device and the semiconductor device according to Example EX_A2 belonging to the embodiment of the present disclosure.

FIG. 13 is an external plan view of two semiconductor devices according to Example EX_A3 belonging to the embodiment of the present disclosure.

FIG. 14 is a diagram for explaining a relationship between two voltage regulating devices and a semiconductor device according to Example EX_A3 belonging to the embodiment of the present disclosure.

FIG. 15 is a schematic configuration diagram of a voltage regulating device according to Example EX_A4 belonging to the embodiment of the present disclosure.

FIG. 16 is a partial circuit diagram of the voltage regulating device according to Example EX_A4 belonging to the embodiment of the present disclosure.

FIG. 17 is a circuit diagram of a voltage regulating device according to Example EX_B1 belonging to the embodiment of the present disclosure.

FIG. 18 is a circuit diagram of a voltage regulating device according to Example EX_B2 belonging to the embodiment of the present disclosure.

FIG. 19 is a configuration diagram of a voltage regulating device according to Example EX_B3 belonging to the embodiment of the present disclosure.

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

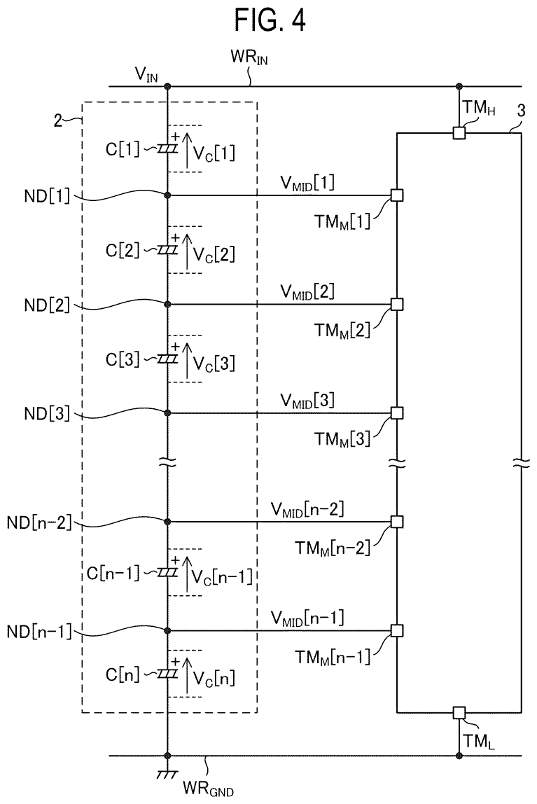

Examples of embodiments of the present disclosure will be specifically described below with reference to the drawings. Throughout the referred drawings, the same parts are denoted by the same reference numerals, and duplicate explanation thereof will be omitted in principle. In the present disclosure, for the sake of simplification of description, by describing a symbol or a code that refers to information, a signal, a physical quantity, a functional part, a circuit, an element, a component, or the like, a name of the information, the signal, the physical quantity, the functional part, the circuit, the element, the component, or the like, which corresponds to the symbol or the code, may be omitted or abbreviated. For example, a high-side terminal referred to by “TM_{H}” (see FIG. 4), which will be described later, may be written as a high-side terminal TM_{H}, or may be abbreviated as a terminal TM_{H}, but they all refer to the same thing.

First, some terms used in the description of the embodiments of the present disclosure will be explained. A ground refers to a reference conductor having a reference potential of 0 V (zero volts) or refers to a potential of 0 V itself. The reference conductor may be formed of a conductor such as metal. The potential of 0 V may be referred to as a ground potential. In the embodiments of the present disclosure, a voltage shown without any particular reference represents a potential seen from the ground.

For any transistor configured as a field effect transistor (FET) such as a MOSFET, an on state refers to a state in which a drain and a source of the transistor are electrically connected to each other, and an off state refers to a state in which the drain and the source of the transistor are electrically disconnected (cut-off state) from each other. The same also applies to transistors that are not classified as FETs. Unless otherwise specified, a MOSFET is regarded as an enhancement type MOSFET. MOSFET is an abbreviation for “metal-oxide-semiconductor field-effect transistor.” Further, it may be considered that a back gate is short-circuited to a source in any MOSFET unless otherwise specified. Hereinafter, for any transistor, an on state and an off state may be simply expressed as on and off, respectively.

A connection between a plurality of parts forming a circuit, such as arbitrary circuit elements, wirings, and nodes, may be understood to refer to an electrical connection, unless otherwise specified. When any two voltages to be compared are voltages v1 and v2, “v1>v2” indicates that the voltage v1 is higher than the voltage v2, “v1<v2” indicates that the voltage v1 is lower than the voltage v2, and “v1=v2” indicates that the value of voltage v1 is the same as the value of voltage v2. The same also applies to other equations that include physical quantities other than a voltage.

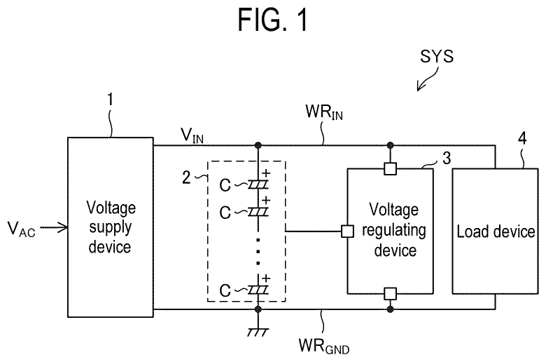

FIG. 1 shows a schematic overall configuration of a circuit system SYS according to an embodiment of the present disclosure. The circuit system SYS includes a voltage supply device 1, a capacitance device 2, a voltage regulating device 3, and a load device 4. The voltage supply device 1, the capacitance device 2, the voltage regulating device 3, and the load device 4 are each connected to a wiring WR_{IN}, which is an input voltage wiring, and a wiring WR_{GND}, which is a ground wiring. The wiring WR_{GND} is connected to the ground. Therefore, a potential at the wiring WR_{GND} is 0 V (zero volts).

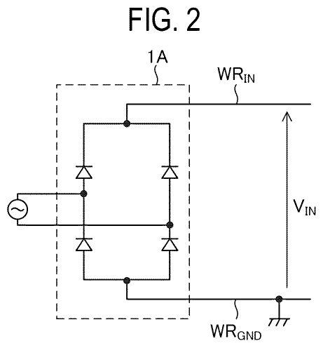

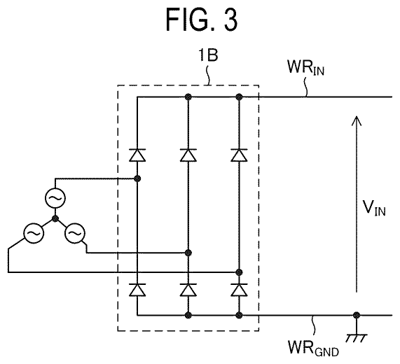

The voltage supply device 1 supplies an input voltage V_{IN}, which is a positive voltage with respect to the potential of the wiring WR_{GND}, to the wiring WR_{IN} based on an AC voltage V_{AC} supplied from outside. An example of a configuration of the voltage supply device 1 is shown in FIG. 2 and FIG. 3. As shown in FIG. 2, the voltage supply device 1 may be a single-phase full-wave rectifier circuit 1A, which receives a single-phase AC voltage as the AC voltage V_{AC} and generates the input voltage V_{IN} by full-wave rectifying the single-phase AC voltage. Alternatively, as shown in FIG. 3, the voltage supply device 1 may be a three-phase full-wave rectifier circuit 1B, which receives a three-phase AC voltage as the AC voltage V_{AC} and generates the input voltage V_{IN} by full-wave rectifying the three-phase AC voltage. In addition, the voltage supply device 1 may be a half-wave rectifier circuit, which generates the input voltage V_{IN} by performing half-wave rectification on a single-phase or three-phase AC voltage. Although not shown in particular, the voltage supply device 1 may have a noise reduction circuit that reduces noise in the AC voltage V_{AC}, in addition to the full-wave rectifier circuit 1A or 1B.

In any case, during a period when the AC voltage V_{AC} is input to the voltage supply device 1, a pulsating voltage having a magnitude corresponding to an effective value of the AC voltage V_{AC} is applied to the wiring WR_{IN} as the input voltage V_{IN}. That is, the pulsating voltage is applied to the wiring WR_{IN} based on the potential of the wiring WR_{GND}, and an instantaneous value of a voltage at the wiring WR_{IN} is equal to an instantaneous value of the pulsating voltage. The voltage supply device 1 may be a DC voltage source that supplies a DC voltage to the wiring WR_{IN} based on the potential of the wiring WR_{GND}.

The capacitance device 2 is a series circuit of a plurality of capacitors C provided between the wirings WR_{IN} and WR_{GND}. The capacitance device 2 accumulates charges corresponding to a combined capacitance of the plurality of capacitors C and the input voltage V_{IN}. Each capacitor C in the capacitance device 2 is an electrolytic capacitor. The voltage regulating device 3 is connected to the series circuit of the plurality of capacitors C and regulates an electrode-to-electrode voltage of each capacitor C. The load device 4 operates according to the input voltage V_{IN}. The load device 4 may include an insulated DC/DC converter, which uses a transformer and a switching transistor to convert the input voltage V_{IN} in a primary-side circuit to an output voltage (a DC voltage different from the input voltage V_{IN}) in a secondary-side circuit. The load device 4 may include any load that operates based on the input voltage V_{IN} or the output voltage generated by the insulated DC/DC converter.

Configurations and connection relationships of the capacitance device 2 and the voltage regulating device 3 are shown with reference to FIG. 4. The capacitance device 2 and the voltage regulating device 3 form a charge storage system. The capacitance device 2 is formed by a series circuit of n capacitors C, where n represents any integer equal to or greater than 2. In the following, when distinguishing the n capacitors C from one another, the n capacitors C will be referred to as capacitors C[1] to C[n]. Each of the capacitors C[1] to C[n] is an electrolytic capacitor and has an anode and a cathode. In the electrolytic capacitor, the anode and cathode are sometimes called a positive electrode and a negative electrode, respectively. Electrolyte in the electrolytic capacitor may be a liquid electrolyte or a solid electrolyte. It is mainly assumed that aluminum electrolytic capacitors are used for the capacitors C[1] to C[n]. However, electrolytic capacitors (for example, tantalum electrolytic capacitors or niobium electrolytic capacitors) other than the aluminum electrolytic capacitors may be used for the capacitors C[1] to C[n].

The capacitors C[1] to C[n] may have the same breakdown voltage and the same capacitance value. However, the capacitors C[1] to C[n] may include two or more capacitors C having different breakdown voltages, or may include two or more capacitors C having different capacitance values. In the following, unless otherwise specified, the capacitors C[1] to C[n] are assumed to have the same breakdown voltage and the same capacitance value.

The anode of the capacitor C[1] is connected to the wiring WR_{IN}. The cathode of the capacitor C[n] is connected to the wiring WR_{GND}. Nodes ND[1] to ND[n−1] are formed in the series circuit of capacitors C[1] to C[n]. A node ND[i] is a connection node between a cathode of a capacitor C[i] and an anode of a capacitor C[i+1]. That is, the cathode of the capacitor C[i] and the anode of the capacitor C[i+1] are connected in common to the node ND[i], where i represents any integer. Therefore, the cathode of the capacitor C[1] and the anode of the capacitor C[2] are connected in common to the node ND[1]. When “n≥3,” the cathode of the capacitor C[2] and the anode of the capacitor C[3] are connected in common to the node ND[2]. The same also applies to the nodes ND[3] to ND[n−1].

The voltage regulating device 3 has the high-side terminal TM_{H} connected to the wiring WR_{IN} and a low-side terminal TM_{L} connected to the wiring WR_{GND}. The input voltage V_{IN} is applied to the high-side terminal TM_{H}. A potential of the low-side terminal TM_{L} is 0 V (zero volts). The voltage regulating device 3 further has a total of (n−1) middle terminals TM_{M}. The total of (n−1) middle terminals TM_{H} are formed by middle terminals TM_{M}[1] to TM_{M}[n−1]. The middle terminals TM_{H} [1] to TM_{M}[n−1] are connected to the nodes ND[1] to ND[n−1], respectively, via a total of (n−1) wirings provided outside the voltage regulating device 3. That is, a middle terminal TM_{M}[i] is connected to the node ND[i], and is therefore connected to the cathode of the capacitor C[i] and the anode of the capacitor C[i+1].

Voltages at the nodes ND[1] to ND[n−1] are referred to as middle voltages V_{MID}[1] to V_{MID}[n−1], respectively. That is, the voltage at the node ND[i] and the middle terminal TM_{M}[i] is a middle voltage V_{MID}[i]. An electrode-to-electrode voltage of the capacitor C[i] is represented by a symbol “V_{C}[i].” The electrode-to-electrode voltage V_{C}[i] represents a potential of the anode of the capacitor C[i] as viewed from a potential of the cathode of the capacitor C[i]. Therefore, “V_{MID}[1]+V_{C}[1]=V_{IN}” and “V_{MID}[2]+V_{C}[2]=V_{MID}[1].” The same is true for the middle voltages V_{MID}[3] to V_{MID}[n−1]. Hereinafter, the electrode-to-electrode voltage V_{C}[i] may be abbreviated simply as a voltage V_{C}[i]. A sum of the voltages V_{C}[1] to V_{C}[n] is equal to the input voltage V_{IN}.

By the way, after a DC voltage of appropriate polarity is applied to an electrolytic capacitor and the electrolytic capacitor is charged, ideally, no current will flow through the electrolytic capacitor, but actually, a very small current will flow through the electrolytic capacitor as a leakage current. There is a large difference in leakage current among individual capacitors. That is, the leakage current can vary significantly among a plurality of electrolytic capacitors. Further, the leakage current varies according to a temperature of the electrolytic capacitor, and also according to a time that has elapsed after the DC voltage was applied to the electrolytic capacitor. For these reasons, when a DC voltage is applied to a series circuit of the plurality of electrolytic capacitors, voltages applied to respective electrolytic capacitors can become uneven.

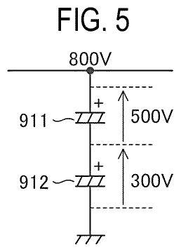

For example, in a system in which a maximum voltage of 800 V (volts) is expected to be applied to a series circuit of two electrolytic capacitors, when it is assumed that voltages applied to the respective electrolytic capacitors are even, electrolytic capacitors 911 and 912, each having a breakdown voltage of 450 V, can be connected in series as shown in FIG. 5. However, actually, due to generation of the above-mentioned unevenness, it may happen that 300 V is applied to one electrolytic capacitor and 500 V is applied to the other electrolytic capacitor (an excessive breakdown voltage may be generated).

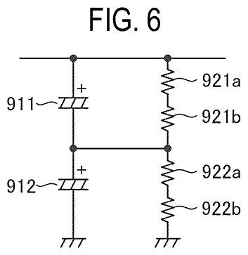

For this reason, a reference configuration is considered in which balancing resistors are provided in parallel with each electrolytic capacitor as shown in FIG. 6. In the reference configuration of FIG. 6, the electrolytic capacitors 911 and 912 are connected in series, a first balancing resistor is connected in parallel to the electrolytic capacitor 911, and a second balancing resistor is connected in parallel to the electrolytic capacitor 912. Since each balancing resistor requires a large breakdown voltage, each balancing resistor is formed by a plurality of resistors. In FIG. 6, the first balancing resistor corresponding to the electrolytic capacitor 911 is formed by a series circuit of resistors 921a and 921b, and the second balancing resistor corresponding to the electrolytic capacitor 912 is formed by a series circuit of resistors 922a and 922b.

By providing the balancing resistors, it is possible to equalize an electrode-to-electrode voltage of the electrolytic capacitor 911 and an electrode-to-electrode voltage of the electrolytic capacitor 912 against a difference in leakage current. However, when the balancing resistors are provided, a loss is constantly generated in the balancing resistors. For example, when 400 V is applied to the series circuit of electrolytic capacitors 911 and 912 and each of the resistors 921a, 921b, 922a, and 922b has a resistance value of 220 kΩ (kilo-ohms), since “400 V×400 V/880 kΩ⇄0.182 W,” a loss of approximately 0.182 W (watts) is constantly generated in the balancing resistor group (921a, 921b, 922a, and 922b). In addition, since the four resistors (921a, 921b, 922a, and 922b) having high breakdown voltages that can tolerate large heat loss are required, an installation area of the balancing resistors also becomes considerably large.

Details will be clear from explanation to be described later, but by using the voltage regulating device 3, it is possible to suppress the electrolytic capacitor from exceeding the breakdown voltage while achieving a low loss and savings in area, compared to the reference configuration.

Hereinafter, among a plurality of examples, several specific configuration examples, operation examples, application techniques, modification techniques, and the like relating to the voltage regulating device 3 will be described. Those described above with respect to the present embodiment are applied to each of the following examples unless otherwise stated and unless contradictory. When details of each example are incompatible with those described above, descriptions in each example may take precedence. In addition, as long as there is no contradiction, details described in any of the following examples can be applied to any other examples (i.e., it is also possible to combine any two or more of the examples).

### Example EX_A1

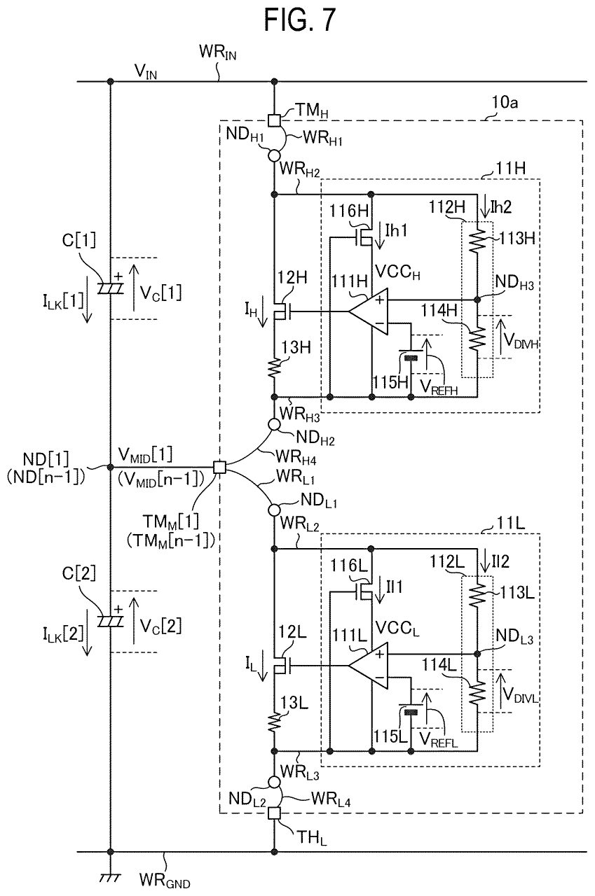

Example EX_A1 will be described. In Example EX_A1, “n=2.” FIG. 7 shows a circuit diagram of a voltage regulating device 10a, which is the voltage regulating device 3 in Example EX_A1. A leakage current of the capacitor C[i] is represented by a symbol “I_{LK}[i].”

The voltage regulating device 10a has the high-side terminal TM_{H}, the low-side terminal TM_{L}, and the middle terminal TM_{M}[1]. The voltage regulating device 10a also has a high-side controller 11H, a transistor (high-side transistor) 12H, a current limiting resistor 13H, a low-side controller 11L, a transistor (low-side transistor) 12L, and a current limiting resistor 13L, and these (11H to 13H and 11L to 13L) form a voltage limiting circuit that limits the electrode-to-electrode voltages V_{C}[1] and V_{C}[2]. In addition, nodes ND_{H1} to ND_{H3} and ND_{L1} to ND_{L3} and wirings WR_{H1} to WR_{H4} and WR_{L1} to WR_{L4} are provided in the voltage regulating device 10a.

The high-side controller 11H includes an amplifier 111H, which is an operational amplifier, a voltage divider circuit 112H formed by voltage dividing resistors 113H and 114H, a reference voltage source 115H, and a transistor 116H. The low-side controller 11L includes an amplifier 111L, which is an operational amplifier, a voltage divider circuit 112L formed by voltage dividing resistors 113L and 114L, a reference voltage source 115L, and a transistor 116L. The transistors 12H and 12L are N-channel type MOSFETs. The transistors 116H and 116L are N-channel type JFETs. JFET is an abbreviation for junction field effect transistor. The transistors 116H and 116L are normally-on JFETs. Therefore, even when a gate-source voltage of the transistor 116H is 0 V, a drain and a source of the transistor 116H are conductive to each other, and even when a gate-source voltage of the transistor 116L is 0 V, a drain and a source of the transistor 116L are conductive to each other.

High-breakdown voltage components that can withstand a voltage difference (V_{IN}−V_{MID}[1]) are used for the transistors 12H and 116H and the voltage dividing resistor 113H. That is, in the circuit system SYS, a voltage (V_{IN}−V_{MID}[1]) applied between the high-side terminal TM_{H} and the middle terminal TM_{M}[1] fluctuates within a predetermined high-side voltage range, but breakdown voltages of the transistors 12H and 116H and a breakdown voltage of the voltage dividing resistor 113H are higher than an upper limit voltage (e.g., 220 V) within the high-side voltage range. Similarly, high-breakdown voltage components that can withstand a voltage difference (V_{MID}[1]−0) are used for the transistors 12L and 116L and the voltage dividing resistor 113L. That is, in the circuit system SYS, a voltage (i.e., the middle voltage V_{MID}[1]) applied between the middle terminal TM_{M}[1] and the low-side terminal TM_{L} fluctuates within a predetermined low-side voltage range, but breakdown voltages of the transistors 12L and 116L and a breakdown voltage of the voltage dividing resistor 113L are higher than an upper limit voltage (e.g., 220 V) within the low-side voltage range.

Outside the voltage regulating device 10a, the high-side terminal TM_{H} is connected to the wiring WR_{IN}, and the low-side terminal TM_{L} is connected to the wiring WR_{GND}. Outside the voltage regulating device 10a, the middle terminal TM_{M}[1] is connected to the cathode of the capacitor C[1] and the anode of the capacitor C[2] via the node ND[1]. That is, the node ND[1] is located between the cathode of the capacitor C[1] and the anode of the capacitor C[2] and the middle terminal TM_{M}[1].

Configurations and operations between the high-side terminal TM_{H} and the middle terminal TM_{M}[1] will be described. The node ND_{H1} is connected to the high-side terminal TM_{H} via the wiring WR_{H1} and is also connected to the wiring WR_{H2}. Therefore, the input voltage V_{IN} is applied to the node ND_{H1} and the wirings WR_{H1} and WR_{H2}. The node ND_{H1} is located between the wirings WR_{H1} and WR_{H2}. The node ND_{H2} is connected to the middle terminal TM_{M}[1] via the wiring WR_{H4} and is also connected to the wiring WR_{H3}. Therefore, the middle voltage V_{MID}[1] is applied to the node ND_{H2} and the wirings WR_{H3} and WR_{H4}. The node ND_{H2} is located between the wirings WR_{H3} and WR_{H4}.

A drain of the transistor 12H, a drain of the transistor 116H, and a first end of the voltage dividing resistor 113H are connected to the wiring WR_{H2}. A second end of the voltage dividing resistor 113H and a first end of the voltage dividing resistor 114H are connected to the node ND_{H3}. A second end of the voltage dividing resistor 114H is connected to the wiring WR_{H3}. The voltage divider circuit 112H generates a voltage V_{DIVH} (high-side divided voltage), which is a divided voltage of a voltage between the high-side terminal TM_{H} and the middle terminal TM_{M}[1]. The voltage V_{DIVH} is equal to a voltage drop generated by the voltage dividing resistor 114H. Therefore, a voltage (V_{MID}[1]+V_{DIVH}), which is higher by the voltage V_{DIVH} than the middle voltage V_{MID}[1], is applied to the node ND_{H3}.

A source of the transistor 12H is connected to a first end of the current limiting resistor 13H, and a second end of the current limiting resistor 13H is connected to the wiring WR_{H3}. A gate of the transistor 116H is connected to the wiring WR_{H3}. An output terminal of the amplifier 111H is connected to a gate of the transistor 12H. A source of the transistor 116H is connected to a positive power supply terminal of the amplifier 111H, and a negative power supply terminal of the amplifier 111H is connected to the wiring WR_{H3}. As described above, since the transistor 116H is a normally-on JFET, a voltage VCC_{H} applied to the source of the transistor 116H is higher by a magnitude of a gate threshold voltage (for example, 3 V) of the transistor 116H than a potential of the wiring WR_{H3}. A non-inverting input terminal of the amplifier 111H is connected to the node ND_{H3}, and therefore receives the voltage (V_{MID}[1]+V_{DIVH}). The amplifier 111H operates based on the voltage VCC_{H} of the positive power supply terminal with a potential of the negative power supply terminal as a reference.

The reference voltage source 115H is connected to the wiring WR_{H3} and an inverting input terminal of the amplifier 111H. The reference voltage source 115H operates based on the voltage VCC_{H} and generates a reference voltage V_{REFH} based on a potential at the wiring WR_{H3}. The reference voltage V_{REFH} has a predetermined magnitude (for example, 1 V). The reference voltage source 115H supplies a voltage (V_{MID}[1]+V_{REFH}), which is higher by the reference voltage V_{REFH} than the middle voltage V_{MID}[1], to the inverting input terminal of the amplifier 111H.

The amplifier 111H compares the voltage (V_{MID}[1]+V_{DIVH}) at the node ND_{H3} with the voltage (V_{MID}[1]+V_{REFH}) from the reference voltage source 115H, and supplies an amplified signal of a difference therebetween to the gate of the transistor 12H. This comparison is equivalent to a comparison between the voltages V_{DIVH} and V_{REFH}. The amplifier 111H controls the presence or absence and a magnitude of a drain current of the transistor 12H by controlling the gate voltage of the transistor 12H according to a high-low relationship between the voltages V_{DIVH} and V_{REFH}. The drain current of the transistor 12H is called a regulating current I_{H} (high-side regulating current).

When “V_{DIVH}<V_{REFH}” is established, the amplifier 111H supplies a voltage having the potential of the wiring WR_{H3} to the gate of the transistor 12H, thereby setting the transistor 12H to OFF (i.e., cutting off the transistor 12H). When the transistor 12H is OFF, the regulating current I_{H} is zero. When “V_{DIVH}>V_{REFH}” is established, the amplifier 111H increases the gate voltage of the transistor 12H to set the transistor 12H to ON (making the transistor 12H conductive). When the transistor 12H is ON, the regulating current I_{H} is generated. When “V_{DIVH}>V_{REFH}” holds, as an absolute value of the difference between the voltages V_{DIVH} and V_{REFH} increases, the amplifier 111H increases the gate voltage of the transistor 12H, and the increase in the gate voltage of the transistor 12H also increases the regulating current I_{H}. However, an upper limit of the gate voltage of the transistor 12H is the above-mentioned voltage VCC_{H}. An upper limit is also set for the regulating current I_{H} based on the respective values of the voltage VCC_{H}, the current limiting resistor 13H, and the gate threshold voltage of the transistor 12H.

Configurations and operations between the middle terminal TM_{M}[n−1] and the low-side terminal TM_{L} will be described. In Example EX_A1, since “n=2,” the node ND[n−1], the middle voltage V_{MID}[n−1], and the middle terminal TM_{M}[n−1] are the node ND[1], the middle voltage V_{MID}[1], and the middle terminal TM_{M}[1], respectively. The node ND_{L1} is connected to the middle terminal TM_{M}[n−1] via the wiring WR_{L1}, and is also connected to the wiring WR_{L2}. Therefore, the middle voltage V_{MID}[n−1] is applied to the node ND_{L1} and the wirings WR_{L1} and WR_{L2}. The node ND_{L1} is located between the wirings WR_{L1} and WR_{L2}. The node ND_{L2} is connected to the low-side terminal TM_{L} via the wiring WR_{L4}, and is also connected to the wiring WR_{L3}. Therefore, voltages at the node ND_{L2} and the wirings WR_{L3} and WR_{L4} are 0 V. The node ND_{L2} is located between the wirings WR_{L3} and WR_{L4}.

A drain of the transistor 12L, a drain of the transistor 116L, and a first end of the voltage dividing resistor 113L are connected to the wiring WR_{L2}. A second end of the voltage dividing resistor 113L and a first end of the voltage dividing resistor 114L are connected to the node ND_{L3}. A second end of the voltage dividing resistor 114L is connected to the wiring WR_{L3}. The voltage divider circuit 112L generates a voltage V_{DIVL} (low-side divided voltage) which is a divided voltage of a voltage between the middle terminal TM_{M}[n−1] and the low-side terminal TM_{L}. The voltage V_{DIVL} is equal to a voltage drop generated by the voltage dividing resistor 114L. Therefore, the voltage V_{DIVL} is applied to the node ND_{L3}.

A source of the transistor 12L is connected to a first end of the current limiting resistor 13L, and a second end of the current limiting resistor 13L is connected to the wiring WR_{L3}. A gate of the transistor 116L is connected to the wiring WR_{L3}. An output terminal of the amplifier 111L is connected to a gate of the transistor 12L. A source of the transistor 116L is connected to a positive power supply terminal of the amplifier 111L, and a negative power supply terminal of the amplifier 111L is connected to the wiring WR_{L3}. As described above, since the transistor 116L is a normally-on JFET, a voltage VCC_{L} applied to the source of the transistor 116L is higher by a magnitude of a gate threshold voltage (for example, 3 V) of the transistor 116L than a potential of the wiring WR_{L3}. A non-inverting input terminal of the amplifier 111L is connected to the node ND_{L3}, and therefore receives the voltage V_{DIVL}. The amplifier 111L operates based on the voltage VCC_{L} of the positive power supply terminal with a potential of the negative power supply terminal as a reference.

The reference voltage source 115L is connected to the wiring WR_{L3} and an inverting input terminal of the amplifier 111L. The reference voltage source 115L operates based on the voltage VCC_{L} and generates a reference voltage V_{REFL} based on a potential at the wiring WR_{L3}. The reference voltage V_{REFL} has a predetermined magnitude (for example, 1 V). The reference voltage source 115L supplies the reference voltage V_{REFL} to the inverting input terminal of the amplifier 111L.

The amplifier 111L compares the voltage V_{DIVL} at the node ND_{L3} with the reference voltage V_{REFL} from the reference voltage source 115L, and supplies an amplified signal of a difference therebetween to the gate of the transistor 12L. The amplifier 111L controls the presence or absence and a magnitude of a drain current of the transistor 12L by controlling a gate voltage of the transistor 12L according to a high-low relationship between the voltages V_{DIVL} and V_{REFL}. The drain current of the transistor 12L is called a regulating current I_{L} (low-side regulating current).

When “V_{DIVL}<V_{REFL}” is established, the amplifier 111L supplies a voltage having the potential of the wiring WR_{L3} to the gate of the transistor 12L, thereby setting the transistor 12L to OFF (i.e., cutting off the transistor 12L). When the transistor 12L is OFF, the regulating current I_{L} is zero. When “V_{DIVL}>V_{REFL}” is established, the amplifier 111L increases the gate voltage of the transistor 12L to set the transistor 12L to ON (making the transistor 12L conductive). When the transistor 12L is ON, the regulating current I_{L} is generated. When “V_{DIVL}>V_{REFL}” holds, as an absolute value of the difference between the voltages V_{DIVL} and V_{REFL} increases, the amplifier 111L increases the gate voltage of the transistor 12L, and the increase in the gate voltage of the transistor 12L also increases the regulating current I_{L}. However, an upper limit of the gate voltage of the transistor 12L is the above-mentioned voltage VCC_{L}. An upper limit is also set for the regulating current I_{L} based on the respective values of the voltage VCC_{L}, the current limiting resistor 13L, and a gate threshold voltage of the transistor 12L.

In addition, a current flowing from the node ND_{H2} to the middle terminal TM_{M}[n−1] is a sum of a consumption current Ih1 of the amplifier 111H corresponding to a drain current of the transistor 116H, a current Ih2 flowing in the voltage divider circuit 112H, and the regulating current I_{H}. A current flowing from the middle terminal TM_{M}[n−1] to the node ND_{L1} is a sum of a consumption current Il1 of the amplifier 111L corresponding to a drain current of the transistor 116L, a current Il2 flowing in the voltage divider circuit 112L, and the regulating current I_{L}. The controllers 11H and 11L have the same configuration, and a potential difference between the wirings WR_{H2} and WR_{H3} is completely or approximately equal to a potential difference between the wirings WR_{L2} and WR_{L3}. Thus, it can be considered that “Ih1=Il1” and “Ih2=Il2.” Therefore, when “I_{H}=I_{L},” a current between the node ND[1] and the middle terminal TM_{M}[1] can be considered to be zero.

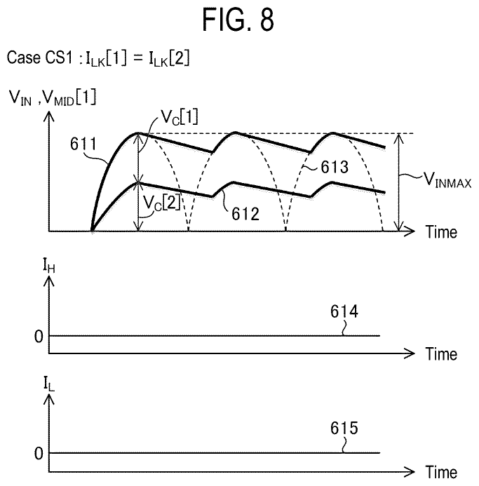

An operation of the voltage regulating device 10a in case CS1 where “I_{LK}[1]=I_{LK}[2]” is established will be described with reference to FIG. 8. In FIG. 8, solid line waveforms 611 and 612 are waveforms of the input voltage V_{IN} and the middle voltage V_{MID}[1] in case CS1, respectively. Here, it is assumed that a full-wave rectified voltage of the AC voltage V_{AC} is output from the voltage supply circuit 1 (see FIG. 1), and a broken waveform 613 in FIG. 8 shows an output voltage waveform of the voltage supply circuit 1 when it is assumed that no smoothing is performed by the capacitance device 2. In FIG. 8, waveforms 614 and 615 are waveforms of the regulating currents I_{H} and I_{L}, respectively, in case CS1.

In conjunction with starting of a supply of the AC voltage V_{AC} to the voltage supply device 1, the input voltage V_{IN} and the middle voltage V_{MID}[1] start to rise from 0 V, and thereafter, the input voltage V_{IN} and the middle voltage V_{MID}[1] fluctuate at a frequency according to a frequency of the AC voltage V_{AC}. In case CS1 where “I_{LK}[1]=I_{LK}[2],” a voltage is equally applied to the capacitors C[1] and C[2], so that “V_{C}[1]=V_{C}[2]=V_{IN}/2” always holds (ignoring errors). A maximum voltage that the input voltage V_{IN} can take in the circuit system SYS is called a maximum input voltage V_{INMAX}. When “n=2,” a breakdown voltage of each of the capacitors C[1] and C[2] is greater than a voltage (V_{INMAX}/2). For example, when the maximum input voltage V_{INMAX} is 400 V in design, an electrolytic capacitor with a breakdown voltage of 250 V is used as the capacitor C[i].

The reference voltage V_{REFH} and a resistance ratio between the voltage dividing resistors 113H and 114H are set so that “V_{DIVH}<V_{REFH}” is established when “V_{C}[1]=V_{INMAX}/2” is established, and the reference voltage V_{REFL} and a resistance ratio between the voltage dividing resistors 113L and 114L are set so that “V_{DIVL}<V_{REFL}” is established when “V_{C}[2]=V_{INMAX}/2” is established. For this reason, in case CS1, the transistors 12H and 12L are always turned off, and therefore the regulating currents I_{H} and I_{L} are maintained at zero. Thus, in case CS1, a current between the node ND[1] and the middle terminal TM_{M}[1] is zero.

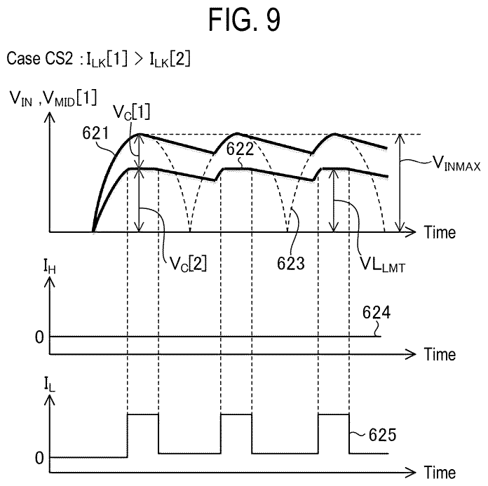

An operation of the voltage regulating device 10a in case CS2 where “I_{LK}[1]>I_{LK}[2]” is established will be described with reference to FIG. 9. In FIG. 9, solid line waveforms 621 and 622 are waveforms of the input voltage V_{IN} and the middle voltage V_{MID}[1], respectively, in case CS2. A broken line waveform 623 in FIG. 9 shows the same as the broken line waveform 613 in FIG. 8. In FIG. 9, waveforms 624 and 625 are waveforms of the regulating currents I_{H} and I_{L}, respectively, in case CS2.

In conjunction with starting a supply of the AC voltage V_{AC} to the voltage supply device 1, the input voltage V_{IN} and the middle voltage V_{MID}[1] start to rise from 0 V, and thereafter, the input voltage V_{IN} and the middle voltage V_{MID}[1] fluctuate at a frequency corresponding to the frequency of the AC voltage V_{AC}. A state in which “I_{LK}[1]>I_{LK}[2]” is established is equivalent to a state in which an internal resistance value of the capacitor C[1] is lower than an internal resistance value of the capacitor C[2]. Therefore, in case CS2, due to the characteristics of the capacitors C[1] and C[2], “V_{C}[1]<V_{C}[2]” is established. Thus, “V_{C}[1]<V_{INMAX}/2” is always established, and therefore “V_{DIVH}<V_{REFH}” is established. As a result, in case CS2, the transistor 12H is always turned off, and therefore the regulating current I_{H} is maintained at zero.

On the other hand, in case CS2, a period during which “V_{C}[2]>V_{INMAX}/2” is established exists. In the period during which “V_{C}[2]>V_{INMAX}/2” is established, “V_{DIVL}>V_{REFL}” may be established according to an instantaneous value of the input voltage V_{IN}. When “V_{DIVL}>V_{REFL}” is established, the amplifier 111L functions to generate the regulating current I_{L} having a magnitude according to a difference between the voltages V_{DIVL} and V_{REFL}. In case CS2, the generated regulating current I_{L} flows in a direction from the node ND[1] toward the middle terminal TM_{M}[1]. In addition, in case CS2, the current Il2 is slightly higher than the current Ih2, but a difference between the currents Ih2 and Il2 is minute and sufficiently lower than the regulating current I_{L} in the period during which “V_{DIVL}>V_{REFL}” is established. For this reason, a magnitude of a current flowing between the node ND[1] and the middle terminal TM_{M}[1] in the period during which “V_{DIVL}>V_{REFL}” is established can be considered to coincide with a magnitude of the regulating current I_{L}.

The regulating current I_{L} based on the establishment of “V_{DIVL}>V_{REFL}” flows from the middle terminal TM_{M}[1] to the low-side terminal TM_{L}, thereby bringing an effect of suppressing an increase in the electrode-to-electrode voltage V_{C}[2] of the capacitor C[2] or lowering the electrode-to-electrode voltage V_{C}[2]. When the state in which “V_{DIVL}>V_{REFL}” is established transitions to a state in which “V_{DIVL}<V_{REFL}” is established due to the regulating current I_{L} greater than zero, “I_{L}=0” will be obtained, and when “V_{DIVL}>V_{REFL}” is established again as a result of the regulating current I_{L} becoming zero, the regulating current I_{L} greater than zero will be generated again, resulting in the above-mentioned effect. Due to this feedback operation, in case CS2, the electrode-to-electrode voltage V_{C}[2] of the capacitor C[2] is limited to a predetermined limit voltage VL_{LIM} or lower. Even when “I_{L}=0” due to a drop in the instantaneous value of the input voltage V_{IN}, “I_{L}=0” is maintained by transitioning to the period during which “V_{DIVL}<V_{REFL}” is established. Thereafter, in case CS2, the period of “I_{L}>0” and the period of “I_{L}=0” appear alternately in conjunction with the fluctuation in the input voltage V_{IN}.

The limit voltage VL_{LIM} corresponds to the electrode-to-electrode voltage V_{C}[2] of the capacitor C[2] when “V_{DIVL}=V_{REFL}” is established, and is determined by the reference voltage V_{REFL} and the resistance ratio between the voltage dividing resistors 113L and 114L. The limit voltage VL_{LIM} is lower than the breakdown voltage of the capacitor C[2]. For example, when the breakdown voltage of the capacitor C[2] is 250 V, the limit voltage VL_{LIM} may be set to 220 V. Therefore, a voltage greater than the breakdown voltage is not applied to the capacitor C[2].

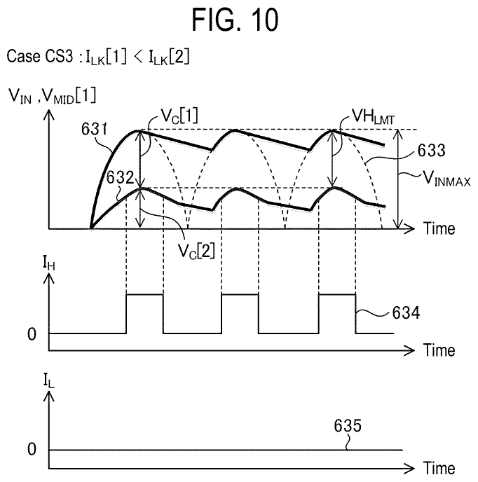

An operation of the voltage regulating device 10a in case CS3 where “I_{LK}[1]<I_{LK}[2]” is established will be described with reference to FIG. 10. In FIG. 10, solid line waveforms 631 and 632 are waveforms of the input voltage V_{IN} and the middle voltage V_{MID}[1], respectively, in case CS3. A broken line waveform 633 in FIG. 10 shows the same as the broken line waveform 613 in FIG. 8. In FIG. 10, waveforms 634 and 635 are waveforms of the regulating currents I_{H} and I_{L}, respectively, in case CS3.

In conjunction with starting a supply of the AC voltage V_{AC} to the voltage supply device 1, the input voltage V_{IN} and the middle voltage V_{MID}[1] start to rise from 0 V, and thereafter, the input voltage V_{IN} and the middle voltage V_{MID}[1] fluctuate at a frequency corresponding to the frequency of the AC voltage V_{AC}. A state in which “I_{LK}[1]<I_{LK}[2]” is established is equivalent to a state in which the internal resistance value of the capacitor C[1] is higher than the internal resistance value of the capacitor C[2]. Therefore, in case CS3, due to the characteristics of the capacitors C[1] and C[2], “V_{C}[1]>V_{C}[2]” is established. Thus, “V_{C}[2]<V_{INMAX}/2” is always established, and therefore “V_{DIVL}<V_{REFL}” is established. As a result, in case CS3, the transistor 12L is always turned off, and therefore the regulating current I_{L} is maintained at zero.

On the other hand, in case CS3, a period during which “V_{C}[1]>V_{INMAX}/2” is established exists. In the period during which “V_{C}[1]>V_{INMAX}/2” is established, “V_{DIVH}>V_{REFH}” may be established according to an instantaneous value of the input voltage V_{IN}. When “V_{DIVH}>V_{REFH}” is established, the amplifier 111H functions to generate the regulating current I_{H} having a magnitude according to a difference between the voltages V_{DIVH} and V_{REFH}. In case CS3, the generated regulating current I_{H} flows in a direction from the middle terminal TM_{M}[1] toward the node ND[1]. In addition, in case CS3, the current Ih2 is slightly higher than the current Il2, but a difference between the currents Ih2 and Il2 is minute and sufficiently lower than the regulating current I_{H} in the period during which “V_{DIVH}>V_{REFH}” is established. For this reason, a magnitude of a current flowing between the middle terminal TM_{M}[1] and the node ND[1] in the period during which “V_{DIVH}>V_{REFH}” is established can be considered to coincide with a magnitude of the regulating current I_{H}.

The regulating current I_{H} based on the establishment of “V_{DIVH}>V_{REFH}” flows from the high-side terminal TM_{H} to the middle terminal TM_{M}[1], thereby bringing an effect of suppressing an increase in the electrode-to-electrode voltage V_{C}[1] of the capacitor C[1] or lowering the electrode-to-electrode voltage V_{C}[1]. When the state in which “V_{DIVH}>V_{REFH}” is established transitions to a state in which “V_{DIVH}<V_{REFH}” is established due to the regulating current I_{H} greater than zero, “I_{H}=0” will be obtained, and when “V_{DIVH}>V_{REFH}” is established again as a result of the regulating current I_{H} becoming zero, the regulating current I_{H} greater than zero will be generated again, resulting in the above-mentioned effect. Due to this feedback operation, in case CS3, the electrode-to-electrode voltage V_{C}[1] of the capacitor C[1] is limited to a predetermined limit voltage VH_{LIM} or lower. Even when “I_{H}=0” due to a drop in the instantaneous value of the input voltage V_{IN}, “I_{H}=0” is maintained by transitioning to the period during which “V_{DIVH}<V_{REFH}” is established. Thereafter, in case CS3, the period of “I_{H}>0” and the period of “I_{H}=0” appear alternately in conjunction with the fluctuation in the input voltage V_{IN}.

The limit voltage VH_{LIM} corresponds to the electrode-to-electrode voltage V_{C}[1] of the capacitor C[1] when “V_{DIVH}=V_{REFH}” is established, and is determined by the reference voltage V_{REFH} and the resistance ratio between the voltage dividing resistors 113H and 114H. The limit voltage VH_{LIM} is lower than the breakdown voltage of the capacitor C[1]. For example, when the breakdown voltage of the capacitor C[1] is 250 V, the limit voltage VH_{LIM} may be set to 220 V. Therefore, a voltage greater than the breakdown voltage is not applied to the capacitor C[1].

For convenience of description, the operations in cases CS1 to CS3 have been described separately, but the voltage regulating circuit 10a limits the electrode-to-electrode voltage V_{C}[1] of the capacitor C[1] to the limit voltage VH_{LIM} or lower, and limits the electrode-to-electrode voltage V_{C}[2] of the capacitor C[2] to the limit voltage VL_{LIM} or lower. It is mainly assumed that the limit voltage VH_{LIM} and the limit voltage VL_{LIM} have the same voltage value, but as a variant, they may have different voltage values.

Specific numerical examples are given. For simplicity, it is assumed that the input voltage V_{IN} is constant at 400 V and “V_{C}[1]=V_{C}[2]=V_{IN}/2.” The current consumption (Ih1, Il1) of each of the amplifiers 111H and 111L is about 10 μA. It is assumed that a series resistance value of the voltage dividing resistors 113H and 114H and a series resistance value of the voltage dividing resistors 113L and 114L are both 100 MΩ (mega-ohms). Thus, the currents Ih2 and Il2 are both 2 μA. Therefore, when “I_{H}=I_{L}=0,” power consumption of the voltage regulating device 10a is 0.0048 W from “200 V×12 μA×2=0.0048 W,” which is much smaller than the loss of about 0.182 W that is generated constantly in the reference configuration of FIG. 6. Here, 0.0048 W corresponds to standby power of the voltage regulating device 10a. As long as the voltages V_{C}[1] and V_{C}[2] are uneven and “V_{DIVH}>V_{REFH}” or “V_{DIVL}>V_{REFL}” is not established, the voltage regulating device 10a consumes only an extremely small amount of standby power.

Since the leakage current I_{LK}[i] is at most several hundred μA, the amplifiers 111H and 111L may be designed and the values of the current limiting resistors 13H and 13L may be determined in advance, so that the regulating currents I_{H} and I_{L} of about 1 mA (milli-amperes) to several mA are generated. As each current limiting resistor (13H, 13L), a resistance of several kΩ (kilo-ohms) can be used. It is known that a leakage current of an electrolytic capacitor is generated in large amounts immediately after a voltage is applied to the electrolytic capacitor, and that the leakage current decreases significantly and converges after several tens of seconds have passed since the start of the voltage application to the electrolytic capacitor. For this reason, even when the voltages V_{C}[1] and V_{C}[2] are uneven, the regulating current I_{H} or I_{L} is generated for only a very limited time, and the power consumption due to the regulating current I_{H} or I_{L} is suppressed to be kept sufficiently low compared to the reference configuration of FIG. 6.

In addition, by integrating the voltage regulating device 10a by using semiconductors, an installation area (e.g., 5 mm×5 mm) of the voltage regulating device 10a can be suppressed to be kept much smaller than an installation area (e.g., 20 mm×20 mm) of the four high-breakdown voltage resistors (921a, 921b, 922a, and 922b).

A value of the voltage dividing resistor 113H is much larger than a value of the voltage dividing resistor 114H, and most of the voltage between the wirings WR_{H2} and WR_{H3} is applied to the voltage dividing resistor 113H. Specifically, for example, a ratio between the value of the voltage dividing resistor 113H and the value of the voltage dividing resistor 114H is set to 199:1 (this ratio may be determined according to the desired limit voltage VH_{LIM}). Similarly, a value of the voltage dividing resistor 113L is much larger than a value of the voltage dividing resistor 114L, and most of the voltage between the wirings WR_{L2} and WR_{L3} is applied to the voltage dividing resistor 113L. Specifically, for example, a ratio between the value of the voltage dividing resistor 113L and the value of the voltage dividing resistor 114L is set to 199:1 (this ratio may be determined according to the desired limit voltage VL_{LIM}).

### Example EX_A2

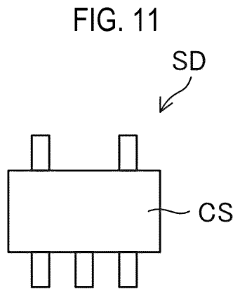

Example EX_A2 will be described. The voltage regulating device 3 in FIG. 1 can be formed by using a semiconductor device. FIG. 11 shows a schematic plan view of a semiconductor device SD. The semiconductor device SD is an electronic component that includes a semiconductor chip having a semiconductor integrated circuit formed on a semiconductor substrate, a housing (package) CS that accommodates the semiconductor chip, and a plurality of external terminals exposed from the housing CS to the outside of the semiconductor device SD. The semiconductor device SD is formed by encapsulating the semiconductor chip in the housing CS made of resin. Further, the number of external terminals of the semiconductor device SD and the type of housing CS of the semiconductor device SD shown in FIG. 11 are merely examples, and they can be designed arbitrarily.

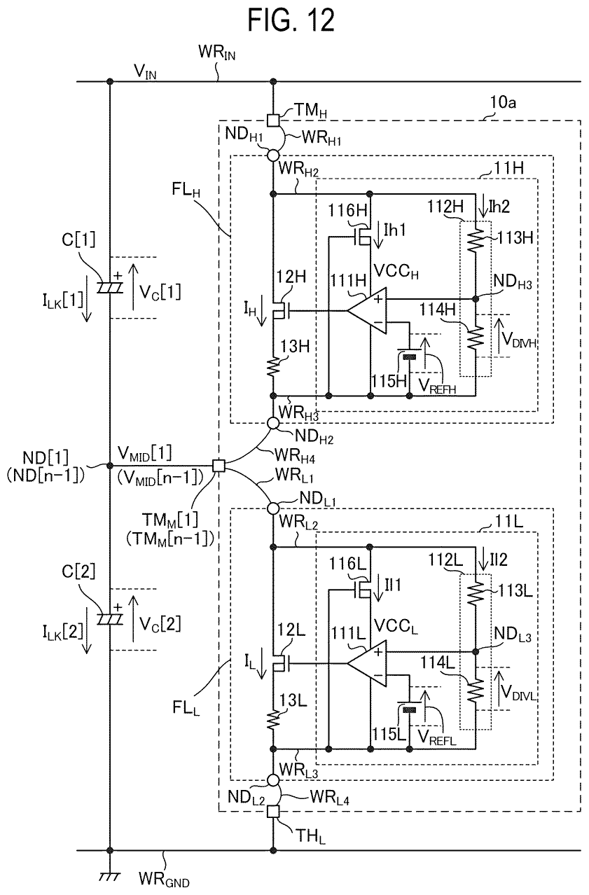

In Example EX_A2, “n=2,” and the voltage regulating device 10a shown in FIG. 7 is formed by one semiconductor device SD. A configuration of the voltage regulating device 10a according to Example EX_A2 will be described with reference to FIG. 12. The voltage regulating device 10a according to Example EX_A2 is one semiconductor device SD itself. The voltage regulating device 10a according to Example EX_A2 has frames FLH and FLL that are metal bodies separated from each other. A first semiconductor chip on which the high-side controller 11H, the transistor 12H, and the current limiting resistor 13H are formed is fixed on the frame FLH, and a second semiconductor chip on which the low-side controller 11L, the transistor 12L, and the current limiting resistor 13L are formed is fixed on the frame FLL. The frame FLH on which the first semiconductor chip is fixed and the frame FLL on which the second semiconductor chip is fixed are accommodated in the single housing CS to form the single semiconductor device SD, which is used as the voltage regulating device 10a.

The terminals TM_{H}, TM_{M}[1], and TM_{L} are external terminals in the voltage regulating device 10a (external terminals of the semiconductor device SD). The nodes ND_{H1} and ND_{H2} are pads on the first semiconductor chip, the node ND_{H1} and the high-side terminal TM_{H} are connected to each other by wire bonding using the wiring WR_{H1}, and the node ND_{H2} and the middle terminal TM_{H} [1] are connected to each other by wire bonding using the wiring WR_{H4}. The nodes ND_{L1} and ND_{L2} are pads on the second semiconductor chip, the node ND_{L1} and the middle terminal TM_{H} [1] are connected to each other by wire bonding using the wiring WR_{L1}, and the node ND_{L2} and the low-side terminal TM_{L} are connected to each other by wire bonding using the wiring WR_{L4}.

Example EX_A2 has an advantage that the voltage regulating device 10a can be formed with the single electronic component (SD). However, it is necessary to provide the frames FLH and FLL that are separated from each other in the housing CS.

### Example EX_A3

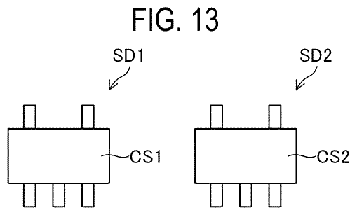

Example EX_A3 will be described. The voltage regulating device 3 in FIG. 1 can be formed by using a plurality of semiconductor devices. FIG. 13 shows a schematic plan view of two semiconductor devices SD1 and SD2. The semiconductor devices SD1 and SD2 are two semiconductor devices having the same configuration. The semiconductor device SD1 is an electronic component including a first semiconductor chip having a semiconductor integrated circuit formed on a semiconductor substrate, a housing (package) CS1 that accommodates the first semiconductor chip, and a plurality of external terminals that are exposed from the housing CS1 to the outside of the semiconductor device SD1. The semiconductor device SD1 is formed by encapsulating the first semiconductor chip in the housing CS1 made of resin. The semiconductor device SD2 is an electronic component including a second semiconductor chip having a semiconductor integrated circuit formed on a semiconductor substrate, a housing (package) CS2 that accommodates the second semiconductor chip, and a plurality of external terminals that are exposed from the housing CS2 to the outside of the semiconductor device SD2. The semiconductor device SD2 is formed by encapsulating the second semiconductor chip in the housing CS2 made of resin. Further, the number of external terminals of each semiconductor device and the type of housing of each semiconductor device shown in FIG. 13 are merely examples, and can be designed arbitrarily.

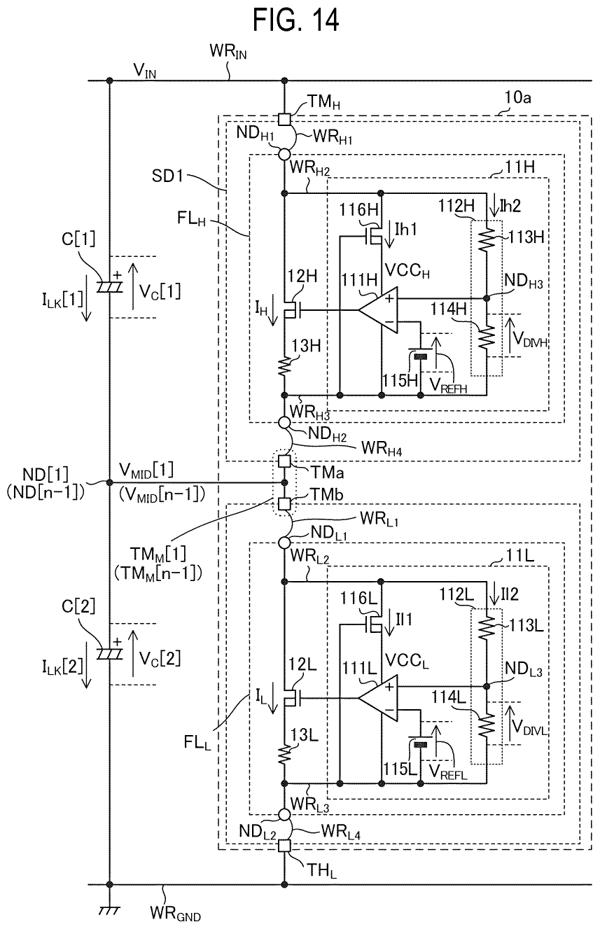

In Example EX_A3, “n=2,” and the voltage regulating device 10a shown in FIG. 7 is formed by the two semiconductor devices SD1 and SD2. A configuration of the voltage regulating device 10a according to Example EX_A3 will be described with reference to FIG. 14. The semiconductor device SD1 has a frame FLH, which is a metal body, and the first semiconductor chip on which the high-side controller 11H, the transistor 12H, and the current limiting resistor 13H are formed is fixed on the frame FLH. The frame FLH on which the first semiconductor chip is fixed is accommodated in the housing CS1 to form the semiconductor device SD1. The semiconductor device SD2 has a frame FLL, which is a metal body, and the second semiconductor chip on which the low-side controller 11L, the transistor 12L, and the current limiting resistor 13L are formed is fixed on the frame FLL. The frame FLL on which the second semiconductor chip is fixed is accommodated in the housing CS2 to form the semiconductor device SD2.

The semiconductor device SD1 has the high-side terminal TM_{H} as an external terminal connected to the node ND_{H1}, and an external terminal TMa connected to the node ND_{H2}. The nodes ND_{H1} and ND_{H2} are pads on the first semiconductor chip. The node ND_{H1} and the high-side terminal TM_{H} are connected to each other by wire bonding using the wiring WR_{H1}. The node ND_{H2} and the external terminal TMa are connected to each other by wire bonding using the wiring WR_{H4}.

The semiconductor device SD2 has the low-side terminal TM_{L} as an external terminal connected to the node ND_{L2}, and an external terminal TMb connected to the node ND_{L1}. The nodes ND_{L1} and ND_{L2} are pads on the second semiconductor chip. The node ND_{L2} and the low-side terminal TM_{L} are connected to each other by wire bonding using the wiring WR_{L4}. The node ND_{L1} and the external terminal TMb are connected to each other by wire bonding using the wiring WR_{L1}.

In Example EX_A3, the external terminals TMa and TMb are connected to each other via a wiring provided outside the semiconductor devices SD1 and SD2, and the middle terminal TM_{M}[1] is formed by the external terminals TMa and TMb. It may be understood that a connection node between the external terminals TMa and TMb corresponds to the middle terminal TM_{M}[1]. Thus, in Example EX_A3, voltage limiting circuits (11H to 13H and 11L to 13L) that limit the voltages V_{C}[1] and V_{C}[2] are accommodated in the two housings CS1 and CS2 in a distributed manner.

Unlike Example EX_A2 (see FIG. 12), Example EX_A3 does not require a plurality of frames to be provided in a single housing, which may be advantageous in terms of manufacturing. In addition, it is possible to dispose the semiconductor device SD1 on a printed circuit board in association with the capacitor C[1] and dispose the semiconductor device SD2 on a printed circuit board in association with the capacitor C[2]. Thus, a layout design becomes simple and easy. On the other hand, it is necessary to provide the two electronic components (SD1, SD2) to form the voltage regulating device 10a.

### Example EX_A4

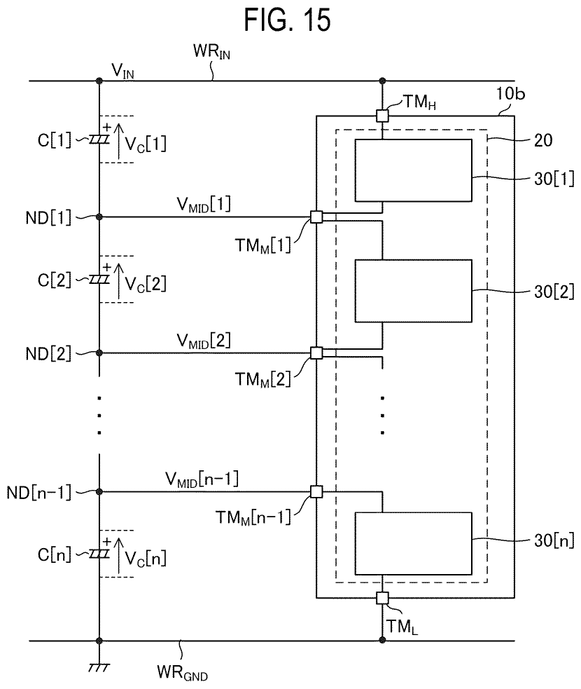

Example EX_A4 will be described. In Examples EX_A1 to EX_A3, it is assumed that “n=2,” but as described above, the value of n is any integer equal to or greater than 2. FIG. 15 shows a schematic configuration of a voltage regulating device 10b according to Example EX_A4. The voltage regulating device 10b is the voltage regulating device 3 according to Example EX_A4 (see FIG. 1). The voltage regulating device 10b includes a voltage limiting circuit 20, the high-side terminal TM_{H}, the middle terminals TM_{M}[1] to TM_{M}[n−1], and the low-side terminal TM_{L}. The voltage limiting circuit 20 limits the electrode-to-electrode voltages of the capacitors C[1] to C[n] to a predetermined limit voltage or lower (i.e., controls each electrode-to-electrode voltage so that the electrode-to-electrode voltages of the capacitors C[1] to C[n] are equal to or lower than a predetermined limit voltage). A total of n limit voltages corresponding to the capacitors C[1] to C[n] are assumed to be equal to one another. However, as a variant, two or more limiting voltages having different voltage values may be included in the total of n limiting voltages corresponding to the capacitors C[1] to C[n].

The voltage limiting circuit 20 includes limiting circuits 30 each assigned to a corresponding one of the capacitors C[1] to C[n]. The limiting circuit 30 assigned to the capacitor C[i] is specifically referred to as a limiting circuit 30[i]. Therefore, the voltage limiting circuit 20 includes the limiting circuits 30[1] to 30[n]. Among the limiting circuits 30[1] to 30[n], the limiting circuit 30[1] can be particularly referred to as a high-side limiting circuit, and the limiting circuit 30[n] can be particularly referred to as a low-side limiting circuit. When “n=2,” the voltage regulating device 10b is the same as the voltage regulating device 10a in FIG. 7. When “n=2,” the voltage limiting circuit 20 in FIG. 15 is formed by the controllers 11H and 11L, the transistors 12H and 12L, and the current limiting resistors 13H and 13L, which are shown in FIG. 7. However, in Example EX_A4, it is considered that “n≥3” is established hereinafter. Among the limiting circuits 30[1] to 30[n], the limiting circuit 30[i], where i is an integer satisfying “2≤i≤n−1,” can be referred to as a middle limiting circuit. In the description of the middle limiting circuit 30[i], the integer i represents any integer that satisfies “2≤i≤n−1.”

The high-side limiting circuit 30[1] is connected to the high-side terminal TM_{H} and the middle terminal TM_{M}[1]. The high-side limiting circuit 30[1] includes the high-side controller 11H, the transistor 12H, and the current limiting resistor 13H, which are shown in FIG. 7. A configuration and an operation of the high-side limiting circuit 30[1] are the same as those of the circuit shown in Example EX_A1, which is formed by the high-side controller 11H, the transistor 12H, and the current limiting resistor 13H. Therefore, the high-side limiting circuit 30[1] limits the voltage (V_{C}[1]) between the high-side terminal TM_{H} and the middle terminal TM_{M}[1] to a predetermined limiting voltage VH_{LIM} or lower by controlling the presence or absence and magnitude of the regulating current I_{H} according to the voltage (V_{C}[1]) between the high-side terminal TM_{H} and the middle terminal TM_{M}[1].

The low-side limiting circuit 30[n] is connected to the middle terminal TM_{M}[n−1] and the low-side terminal TM_{L}. The low-side limiting circuit 30[n] includes the low-side controller 11L, the transistor 12L, and the current limiting resistor 13L, which are shown in FIG. 7. A configuration and an operation of the low-side limiting circuit 30[n] are the same as those of the circuit shown in Example EX_A1, which is formed by the low-side controller 11L, the transistor 12L, and the current limiting resistor 13L. Therefore, the low-side limiting circuit 30[n] limits the voltage (V_{C}[n]) between the middle terminal TM_{M}[n−1] and the low-side terminal TM_{L} to a predetermined limit voltage VL_{LIM} or lower by controlling the presence or absence and magnitude of the regulating current I_{L} according to the voltage (V_{C}[n]) between the middle terminal TM_{M}[n−1] and the low-side terminal TM_{L}.

Each middle limiting circuit is connected to two mutually adjacent middle terminals among the middle terminals TM_{M}[1] to TM_{M}[n−1], and limits a voltage between the two middle terminals to a predetermined limit voltage or lower by controlling the presence or absence and a magnitude of a regulating current between the two middle terminals according to a voltage between the two middle terminals. The two mutually adjacent middle terminals are the middle terminals TM_{M}[i−1] and TM_{M}[i] (where i represents an integer equal to or greater than 2 and equal to or less than (n−1)). Thus, the middle limiting circuit 30[1] is connected to the middle terminals TM_{M}[1] and TM_{M}[2], and limits the voltage (V_{C}[2]) between the middle terminals TM_{M}[1] and TM_{M}[2] to a predetermined limiting voltage or lower (a limiting voltage VM_{LIM} or lower, which will be described later) by controlling the presence or absence and a magnitude of a regulating current between the middle terminals TM_{M}[1] and TM_{M}[2] according to the voltage (V_{C}[2]) between the middle terminals TM_{M}[1] and TM_{M}[2]. Similarly, when “n≥4,” the middle limiting circuit 30[2] is connected to the middle terminals TM_{M}[2] and TM_{M}[3], and limits the voltage (V_{C}[3]) between the middle terminals TM_{M}[2] and TM_{M}[3] to a predetermined limiting voltage or lower (the limiting voltage VM_{LIM} or lower, which will be described later) by controlling the presence or absence and a magnitude of a regulating current between the middle terminals TM_{M}[2] and TM_{M}[3] according to the voltage (V_{C}[3]) between the middle terminals TM_{M}[2] and TM_{M}[3]. Those described above can be generalized as follows: that is, the middle limiting circuit 30[i] is connected to the middle terminals TM_{M}[i−1] and TM_{M}[i], and limits the voltage (V_{C}[i]) between the middle terminals TM_{M}[i−1] and TM_{M}[i] to a predetermined limit voltage or lower (the limit voltage VM_{LIM} or lower, which will be described later) by controlling the presence or absence and a magnitude of a regulating current between the middle terminals TM_{M}[i−1] and TM_{M}[i] according to the voltage (V_{C}[i]) between the middle terminals TM_{M}[i−1] and TM_{M}[i].

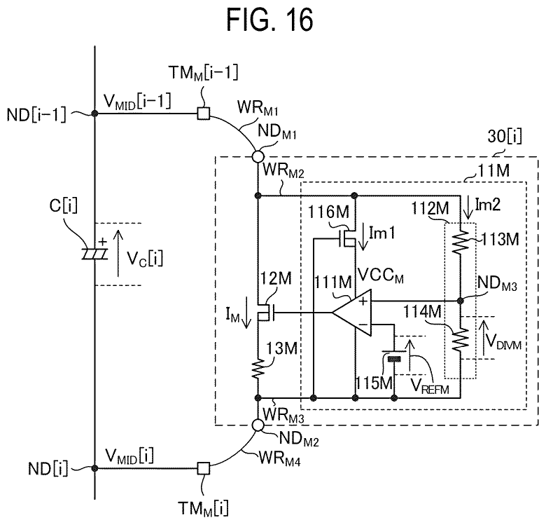

When “n≥4,” (n−2) middle controllers are provided in the voltage regulating device 10b, but configurations and operations of the (n−2) middle controllers are the same as one another. Therefore, a configuration and an operation of the middle limiting circuit 30[i], which is one middle limiting circuit of interest, will be described in detail with reference to FIG. 16. The configuration and the operation of the middle limiting circuit 30[i] are basically the same as those of the high-side limiting circuit 30[1] or the low-side limiting circuit 30[n].

The middle limiting circuit 30[i] includes a middle controller 11M, a transistor (middle transistor) 12M, and a current limiting resistor 13M. In addition, in the voltage regulating device 10b, nodes ND_{M1} to ND_{M3} and wirings WR_{M1} to WR_{M4} are provided in the middle limiting circuit 30[i] or in association with the middle limiting circuit 30[i].

The middle controller 11M includes an amplifier 111M, which is an operational amplifier, a voltage divider circuit 112M consisting of voltage dividing resistors 113M and 114M, a reference voltage source 115M, and a transistor 116M. The transistor 12M is an N-channel type MOSFET. The transistor 116M is an N-channel type JFET. The transistor 116M is a normally-on JFET. Therefore, even when a gate-source voltage of the transistor 116M is 0 V, a drain and a source of the transistor 116M are conductive to each other.

High-breakdown voltage components that can withstand a voltage difference (V_{MID}[i−1]−V_{MID}[i]) are used as the transistors 12M and 116M and the voltage dividing resistor 113M. That is, in the circuit system SYS, the voltage (V_{MID}[i−1]−V_{MID}[i]) applied between the middle terminals TM_{M}[i−1] and TM_{M}[i] fluctuates within a predetermined middle voltage range, but the breakdown voltages of the transistors 12M and 116M and the breakdown voltage of the voltage dividing resistor 113M are higher than an upper limit voltage (e.g., 220 V) of the middle voltage range.

Outside the voltage regulating device 10b, the middle terminal TM_{M}[i−1] is connected to the anode of the capacitor C[i] via the node ND[i−1]. That is, the node ND[i−1] is located between the anode of the capacitor C[i] and the middle terminal TM_{M}[i−1]. Outside the voltage regulating device 10b, the middle terminal TM_{M}[i] is connected to the cathode of the capacitor C[i] via the node ND[i]. That is, the node ND[i] is located between the cathode of the capacitor C[i] and the middle terminal TM_{M}[i].

In the middle limiting circuit 30[i], the node ND_{M1} is connected to the middle terminal TM_{M}[i−1] via the wiring WR_{M1}, and is also connected to the wiring WR_{M2}. Therefore, the middle voltage V_{MID}[i−1] is applied to the node ND_{M1} and the wirings WR_{M1} and WR_{M2}, which correspond to the middle limiting circuit 30[i]. The node ND_{M1} is located between the wirings WR_{M1} and WR_{M2}. In the middle limiting circuit 30[i], the node ND_{M2} is connected to the middle terminal TM_{M}[i] via the wiring WR_{M4}, and is also connected to the wiring WR_{M3}. Therefore, the middle voltage V_{MID}[i] is applied to the node ND_{M2} and the wirings WR_{M3} and WR_{M4}, which correspond to the middle limiting circuit 30[i]. The node ND_{M2} is located between the wirings WR_{M3} and WR_{M4}.

A drain of the transistor 12M, a drain of the transistor 116M, and a first end of the voltage dividing resistor 113M are connected to the wiring WR_{M2}. A second end of the voltage dividing resistor 113M and a first end of the voltage dividing resistor 114M are connected to the node ND_{M3}. A second end of the voltage dividing resistor 114M is connected to the wiring WR_{M3}. The voltage divider circuit 112M generates a voltage V_{DIVM} (middle divided voltage), which is a divided voltage of a voltage between the middle terminals TM_{M}[i−1] and TM_{M}[i]. The voltage V_{DIVM} is equal to a voltage drop generated by the voltage dividing resistor 114M. Therefore, a voltage (V_{MID}[i]+V_{DIVM}), which is higher by the voltage V_{DIVM} than the middle voltage V_{MID}[i], is applied to the node ND_{M3}.

A source of the transistor 12M is connected to a first end of the current limiting resistor 13M, and a second end of the current limiting resistor 13M is connected to the wiring WR_{M3}. A gate of the transistor 116M is connected to the wiring WR_{M3}. An output terminal of the amplifier 111M is connected to a gate of the transistor 12M. A source of the transistor 116M is connected to a positive power supply terminal of the amplifier 111M, and a negative power supply terminal of the amplifier 111M is connected to the wiring WR_{M3}. As described above, since the transistor 116M is a normally-on JFET, a voltage VCC_{M} applied to the source of the transistor 116M is higher by a magnitude of a gate threshold voltage (for example, 3 V) of the transistor 116M than a potential of the wiring WR_{M3}. A non-inverting input terminal of the amplifier 111M is connected to the node ND_{M3}, and therefore receives the voltage (V_{MID}[i]+V_{DIVM}). The amplifier 111M operates based on the voltage VCC_{M} of the positive power supply terminal with a potential of the negative power supply terminal as a reference. The reference voltage source 115M is connected to the wiring WR_{M3} and an inverting input terminal of the amplifier 111M. The reference voltage source 115M operates based on the voltage VCC_{M} and generates a reference voltage V_{REFM} based on the potential at the wiring WR_{M3}. The reference voltage V_{REFM} has a predetermined magnitude (for example, 1 V). The reference voltage source 115M supplies a voltage (V_{MID}[i]+V_{REFM}), which is higher by the reference voltage V_{REFM} than the middle voltage V_{MID}[i], to the inverting input terminal of the amplifier 111M.

The amplifier 111M compares the voltage (V_{MID}[i]+V_{DIVM}) at the node ND_{M3} with the voltage (V_{MID}[i]+V_{REFM}) from the reference voltage source 115M, and supplies an amplified signal of a difference therebetween to the gate of the transistor 12M. This comparison is equivalent to a comparison between the voltages V_{DIVM} and V_{REFM}. The amplifier 111M controls the presence or absence and a magnitude of a drain current of the transistor 12M by controlling a gate voltage of the transistor 12M according to a high-low relationship between the voltages V_{DIVM} and V_{REFM}. The drain current of the transistor 12M is called a regulating current I_{M}.

When “V_{DIVM}<V_{REFM}” is established, the amplifier 111M supplies a voltage having the potential of the wiring WR_{M3} to the gate of the transistor 12M, thereby setting the transistor 12M to OFF (i.e., cutting off the transistor 12M). When the transistor 12M is OFF, the regulating current I_{M} is zero. When “V_{DIVM}>V_{REFM}” is established, the amplifier 111M increases the gate voltage of the transistor 12M to set the transistor 12M to ON (making the transistor 12M conductive). When the transistor 12M is ON, the regulating current I_{M} is generated. When “V_{DIVM}>V_{REFM}” holds, as an absolute value of a difference between the voltages V_{DIVM} and V_{REFM} increases, the amplifier 111M increases the gate voltage of the transistor 12M, and the increase in the gate voltage of the transistor 12M also increases the regulating current I_{M}. However, an upper limit of the gate voltage of the transistor 12M is the voltage VCC_{M} described above. An upper limit is also set for the regulating current I_{M} based on the respective values of the voltage VCC_{M}, the current limiting resistor 13M, and the gate threshold voltage of the transistor 12M.

In addition, a current flowing from the node ND_{M2} to the middle terminal TM_{M}[i] is a sum of a consumption current Im1 of the amplifier 111M corresponding to a drain current of the transistor 116M, a current Im2 flowing in the voltage divider circuit 112M, and the regulating current I_{M}. The controllers 11H, 11M, and 11L have the same configuration, and a potential difference between the wirings WR_{H2} and WR_{H3}, a potential difference between the wirings WR_{M2} and WR_{M3}, and a potential difference between the wirings WR_{L2} and WR_{L3} are completely or approximately equal to one another. Therefore, it can be considered that “Ih1=Im1=Il1” and “Ih2=Im2=Il2.”

Depending on a leakage current of the capacitors C[1] to C[n], “V_{DIVM}>V_{REFM}” may be established according to the instantaneous value of the input voltage V_{IN}. When “V_{DIVM}>V_{REFM}” is established, the amplifier 111M functions to generate the regulating current I_{M} having a magnitude according to the difference between the voltages V_{DIVM} and V_{REFM}. The regulating current I_{M} based on the establishment of “V_{DIVM}>V_{REFM}” flows from the middle terminal TM_{M}[i−1] to the middle terminal TM_{M}[i], thereby bringing an effect of suppressing an increase in the electrode-to-electrode voltage V_{C}[i] of the capacitor C[i] or lowering the electrode-to-electrode voltage V_{C}[i]. When the state in which “V_{DIVM}>V_{REFM}” is established transitions to a state in which “V_{DIVM}<V_{REFM}” is established due to a regulating current I_{M} greater than zero, “I_{M}=0” will be obtained, and when “V_{DIVM}>V_{REFM}” is established again as a result of the regulating current I_{M} becoming zero, the regulating current I_{M} greater than zero will be generated again, resulting in the above-mentioned effect. Due to this feedback operation, the electrode-to-electrode voltage V_{C}[i] of the capacitor C[i] is limited to the predetermined limit voltage VM_{LIM} or lower.

In the middle limiting circuit 30[i], the limiting voltage VM_{LIM} corresponds to the electrode-to-electrode voltage V_{C}[i] of the capacitor C[i] when “V_{DIVM}=V_{REFM}” is established, and is determined by the reference voltage V_{REFM} and a resistance value ratio between the voltage dividing resistors 113M and 114M. The limiting voltage VM_{LIM} is lower than the breakdown voltage of the capacitor C[i]. For example, when the breakdown voltage of the capacitor C[i] is 250 V, the limiting voltage VM_{LIM} may be set to 220 V. Therefore, a voltage higher than the breakdown voltage is not applied to the capacitor C[i].

As shown in Example EX_A2, the voltage regulating device 10b in FIG. 15 may be formed by a single semiconductor device SD. In this case, all of the voltage limiting circuits 20 are accommodated in a single housing CS. In this case, the terminals TM_{M}, TM_{M}[1] to TM_{M}[n−1], and TM_{L} are external terminals in the voltage regulating device 10b (external terminals of the semiconductor device SD).

Alternatively, as shown in Example EX_A3, the voltage regulating device 10b in FIG. 15 may be formed by a plurality of semiconductor devices SD, typically by n semiconductor devices SD. When the voltage regulating device 10b is formed by n semiconductor devices SD, a first to n-th semiconductor devices SD may be provided with the limiting circuits 30[1] to 30[n], respectively, and the limiting circuits 30[1] to 30[n] may be connected in the manner shown in FIG. 15. In this case, the limiting circuits 30[1] to 30[n] are accommodated in a first to n-th housings CS of the first to n-th semiconductor devices SD, respectively. That is, the voltage limiting circuits 20 are accommodated in a distributed manner in the first to n-th housings CS of the first to n-th semiconductor devices SD. The first semiconductor device SD has the high-side terminal TM_{H} as a first external terminal. When “n=3,” a second external terminal provided in the first semiconductor device SD and a first external terminal provided in the second semiconductor device SD are connected to each other and function as the middle terminal TM_{M}[1], a second external terminal provided in the second semiconductor device SD and a first external terminal provided in the third semiconductor device SD are connected to each other and function as the middle terminal TM_{M}[2], and a second external terminal provided in the third semiconductor device SD functions as the low-side terminal TM_{M}. The same also applies when “n≥4.”

### Example EX_A5

Example EX_A5 will be described. Each limiting circuit 30 shown in FIG. 15 is provided with a current limiting resistor (13H, 13M, or 13L). By providing the current limiting resistor, an excessive current is suppressed from flowing through the voltage limiting circuit 20, thereby protecting the voltage regulating device 10b. For example, in the voltage regulating device 10a (see FIG. 7) corresponding to the voltage regulating device 10b when “n=2,” when abnormality such as short-circuiting between both ends of the capacitor C[1] occurs, an excessively large regulating current I_{L} may flow if the current limiting resistor 13L is not provided. However, since the current limiting resistor 13L limits the regulating current I_{L}, the voltage regulating device 10a can be protected.

Each current limiting resistor may be an external resistor provided outside the semiconductor device SD. That is, for example, in Example EX_A2 corresponding to FIG. 11 and FIG. 12, the current limiting resistors 13H and 13L may be provided outside the semiconductor device SD, and in Example EX_A3 corresponding to FIG. 13 and FIG. 14, the current limiting resistors 13H and 13L may be provided outside the semiconductor devices SD1 and SD2. Similarly, in Example EX_A4 corresponding to FIG. 15 and FIG. 16, the current limiting resistors 13H, 13M, and 13L may be provided outside one or more semiconductor devices SD forming the voltage regulating device 10b.

### Example EX_A6

Example EX_A6 will be described. Electrolytic capacitors having various breakdown voltages can be used as the capacitors C[1] to C[n]. In order to arbitrarily set appropriate limit voltages (VH_{LIM}, VM_{LIM}, and VL_{LIM}) according to the breakdown voltages of the respective capacitors, the respective voltage dividing resistors (113H, 114H, 113M, 114M, 113L, and 114L) may be provided outside the semiconductor device SD. With this configuration, it is possible to arbitrarily set and regulate the respective limit voltages (VH_{LIM}, VM_{LIM}, and VL_{LIM}), and the limit voltages VH_{LIM}, VM_{LIM}, and VL_{LIM} can be set to be different from one another.

That is, for example, in Example EX_A2 corresponding to FIG. 11 and FIG. 12, the voltage dividing resistors 113H, 114H, 113L, and 114L may be provided outside the semiconductor device SD, and in Example EX_A3 corresponding to FIG. 13 and FIG. 14, the voltage dividing resistors 113H, 114H, 113L, and 114L may be provided outside the semiconductor devices SD1 and SD2. Similarly, in Example EX_A4 corresponding to FIG. 15 and FIG. 16, the voltage dividing resistors 113H, 114H, 113M, 114M, 113L, and 114L may be provided outside one or more semiconductor devices SD forming the voltage regulating device 10b.

When the voltage dividing resistor 113H is an external resistor for the semiconductor device SD, an expensive resistor with a high breakdown voltage is required as the voltage dividing resistor 113H. Considering this, among the voltage dividing resistors 113H and 114H, the voltage dividing resistor 113H may be built in the semiconductor device SD, and only the voltage dividing resistor 114H may be provided outside the semiconductor device SD. The same also applies to other voltage dividing resistors. That is, for example, in Example EX_A2 corresponding to FIG. 11 and FIG. 12, the voltage dividing resistors 113H and 113L may be built in the semiconductor device SD, while the voltage dividing resistors 114H and 114L may be provided outside the semiconductor device SD, and in Example EX_A3 corresponding to FIG. 13 and FIG. 14, the voltage dividing resistors 113H and 113L may be built in the semiconductor devices SD1 and SD2, respectively, while the voltage dividing resistors 114H and 114L may be provided outside the semiconductor devices SD1 and SD2. Similarly, in Example EX_A4 corresponding to FIG. 15 and FIG. 16, the voltage dividing resistors 113H, 113M, and 113L may be built in one or more semiconductor devices SD forming the voltage regulating device 10b, while the voltage dividing resistors 114H, 114M, and 114L may be provided outside one or more semiconductor devices SD forming the voltage regulating device 10b.

### Example EX_B1

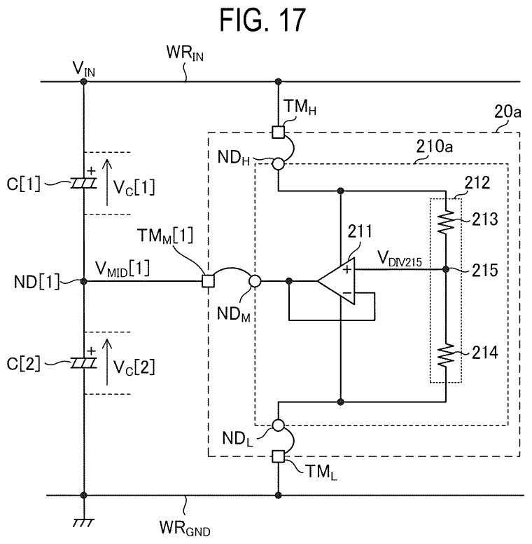

Example EX_B1 will be described. In Example EX_B1, “n=2.” FIG. 17 shows a circuit diagram of a voltage regulating device 20a, which is the voltage regulating device 3 in Example EX_B1.

The voltage regulating device 20a includes a voltage leveling circuit 210a in addition to the high-side terminal TM_{H}, the low-side terminal TM_{L}, and the middle terminal TM_{M}[1]. The voltage leveling circuit 210a includes an amplifier 211, which is an operational amplifier, and a voltage divider circuit 212. The voltage divider circuit 212 includes voltage dividing resistors 213 and 214. Nodes ND_{H}, ND_{M}, and ND_{L} are provided in the voltage regulating device 20a. The voltage regulating device 20a can be formed by the semiconductor device SD (see FIG. 11). In this case, the terminals TM_{H}, TM_{L}, and TM_{M}[1] are provided as external terminals in the semiconductor device SD, and a semiconductor chip on which the voltage leveling circuit 210a is integrated is accommodated in the housing CS. The nodes ND_{H}, ND_{M}, and ND_{L} are pads on the semiconductor chip.

Outside the voltage regulating device 20a, the high-side terminal TM_{H} is connected to the wiring WR_{IN}, and the low-side terminal TM_{L} is connected to the wiring WR_{GND}. Outside the voltage regulating device 20a, the middle terminal TM_{M}[1] is connected to the cathode of the capacitor C[1] and the anode of the capacitor C[2] via the node ND[1]. That is, the node ND[1] is located between the cathode of the capacitor C[1] and the anode of the capacitor C[2] and the middle terminal TM_{M}[1].

The node ND_{H} is connected to the high-side terminal TM_{H}, the node ND_{L} is connected to the low-side terminal TM_{L}, and the node ND_{M} is connected to the middle terminal TM_{M}[1]. A first end of the voltage dividing resistor 213 is connected to the node ND_{H}. A second end of the voltage dividing resistor 213 is connected to a first end of the voltage dividing resistor 214 at a node 215. A second end of the voltage dividing resistor 214 is connected to the node ND_{L}. The voltage divider circuit 212 generates a voltage V_{DIV215}, which is a divided voltage of a voltage between the high-side terminal TM_{H} and the low-side terminal TM_{L}. The voltage V_{DIV215} is equal to a voltage drop generated by the voltage dividing resistor 214. Therefore, the voltage V_{DIV215} is applied to the node 215.

A non-inverting input terminal of the amplifier 211 is connected to the node 215 and receives the voltage V_{DIV215}. An inverting input terminal and an output terminal of the amplifier 211 are connected to the node ND_{M}, and therefore are connected to the node ND[1] via the node ND_{M} and the middle terminal TM_{M}[1]. Therefore, a voltage at the inverting input terminal and the output terminal of the amplifier 211 is the middle voltage V_{MID}[1].

Positive and negative power supply terminals of the amplifier 211 are connected to nodes ND_{H} and ND_{L}, respectively, and the amplifier 211 operates based on the voltage of the positive power supply terminal (hence the input voltage V_{IN}) with a potential of the negative power supply terminal (hence the ground potential) as a reference. For this reason, a high-breakdown voltage amplifier having a breakdown voltage greater than the above-mentioned maximum input voltage V_{INMAX} (see FIG. 8) is used as the amplifier 211.

A resistance ratio of the voltage dividing resistors 213 and 214 is 1:1. That is, a value of the voltage dividing resistor 213 and a value of the voltage dividing resistor 214 are equal to each other (where errors are ignored). For this reason, when errors are ignored, “V_{DIV215}=V_{IN}/2” is established.

When “V_{DIV215}>V_{MID}[1]” is established, the amplifier 211 outputs a current (positive charges) from the output terminal of the amplifier 211 to the node ND[1] via the middle terminal TM_{M}[1], and an output of this current increases the middle voltage V_{MID}[1]. The increase in the middle voltage V_{MID}[1] results in a decrease in the voltage V_{C}[1] and an increase in the voltage V_{C}[2]. The increase in the middle voltage V_{MID}[1] when “V_{DIV215}>V_{MID}[1]” holds reduces a difference between the voltage (V_{IN}/2) and the middle voltage V_{MID}[1], i.e., reduces a difference between the voltages V_{C}[1] and V_{C}[2].

Conversely, when “V_{DIV215}<V_{MID}[1]” is established, the amplifier 211 draws in a current (positive charges) from the node ND[1] via the middle terminal TM_{M}[1] toward the output terminal of the amplifier 211, and this current draw decreases the middle voltage V_{MID}[1]. The decrease of the middle voltage V_{MID}[1] results in an increase in the voltage V_{C}[1] and a decrease in the voltage V_{C}[2]. The decrease of the middle voltage V_{MID}[1] when “V_{DIV215}<V_{MID}[1]” holds reduces the difference between the voltage (V_{IN}/2) and the middle voltage V_{MID}[1], i.e., reduces the difference between the voltages V_{C}[1] and V_{C}[2].

As described above, the amplifier 211 compares the voltage V_{DIV215} (i.e., the voltage (V_{IN}/2)), which is a first comparison voltage, with the middle voltage V_{MID}[1], which is a second comparison voltage, and generates a current according to a result of comparison between the node ND[1] and the middle terminal TM_{M}[1], thereby reducing the difference between the voltages V_{C}[1] and V_{C}[2] (ideally, keeping the difference between the voltages V_{C}[1] and V_{C}[2] at zero). Reducing a difference between any voltages means reducing the difference so that the difference becomes or approaches zero.

The voltage regulating device 20a performs control to make the voltages V_{C}[1] and V_{C}[2] equal to each other even when there is a difference in leakage current between the capacitors C[1] and C[2]. Thus, the capacitors C[1] and C[2] are suppressed from exceeding their breakdown voltages due to the difference in leakage current. For example, when the maximum input voltage V_{INMAX} is 400 V in design, an electrolytic capacitor having a breakdown voltage of 250 V can be used as the capacitor C[i], and the voltage regulating device 20a is provided to maintain the electrode-to-electrode voltage of each capacitor at 200 V or lower. In addition, since a voltage is applied equally to the capacitors C[1] and C[2], voltage dependency of the capacitance value is common between the capacitors C[1] and C[2].

### Example EX_B2

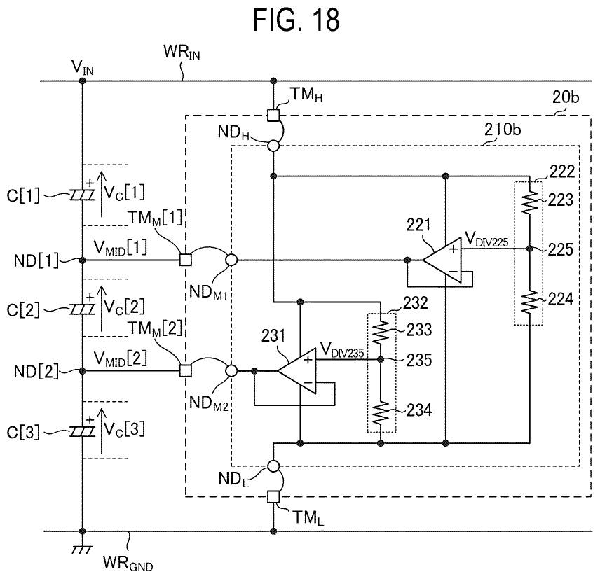

Example EX_B2 will be described. In Example EX_B2, “n=3.” FIG. 18 shows a circuit diagram of a voltage regulating device 20b, which is the voltage regulating device 3 in Example EX_B2.

The voltage regulating device 20b includes a voltage leveling circuit 210b in addition to the high-side terminal TM_{H}, the low-side terminal TM_{L}, and the middle terminals TM_{M}[1] and TM_{M}[2]. The voltage leveling circuit 210b includes amplifiers 221 and 231, which are operational amplifiers, and voltage divider circuits 222 and 232. The voltage divider circuit 222 includes voltage dividing resistors 223 and 224. The voltage divider circuit 232 includes voltage dividing resistors 233 and 234. Nodes ND_{H}, ND_{M1}, ND_{M2}, and ND_{L} are provided in the voltage regulating device 20b. The voltage regulating device 20b can be formed by the semiconductor device SD (see FIG. 11). In this case, the terminals TM_{H}, TM_{L}, TM_{M}[1], and TM_{M}[2] are provided as external terminals in the semiconductor device SD, and a semiconductor chip on which the voltage leveling circuit 210b is integrated is accommodated in the housing CS. The nodes ND_{H}, ND_{M1}, ND_{M2}, and ND_{L} are pads on the semiconductor chip.

Outside the voltage regulating device 20b, the high-side terminal TM_{H} is connected to the wiring WR_{IN}, and the low-side terminal TM_{L} is connected to the wiring WR_{GND}. Outside the voltage regulating device 20b, the middle terminal TM_{M}[1] is connected to the cathode of the capacitor C[1] and the anode of the capacitor C[2] via the node ND[1]. That is, the node ND[1] is located between the cathode of the capacitor C[1] and the anode of the capacitor C[2] and the middle terminal TM_{M}[1]. Outside the voltage regulating device 20b, the middle terminal TM_{M}[2] is connected to the cathode of the capacitor C[2] and the anode of the capacitor C[3] via the node ND[2]. That is, the node ND[2] is located between the cathode of the capacitor C[2] and the anode of the capacitor C[3] and the middle terminal TM_{M}[2]. The node ND_{H} is connected to the high-side terminal TM_{H}, and the node ND_{L} is connected to the low-side terminal TM_{L}. The nodes ND_{M1} and ND_{M2} are connected to the middle terminals TM_{M}[1] and TM_{M}[2], respectively.

A first end of the voltage dividing resistor 223 is connected to the node ND_{H}. A second end of the voltage dividing resistor 223 is connected to a first end of the voltage dividing resistor 224 at a node 225. A second end of the voltage dividing resistor 224 is connected to the node ND_{L}. The voltage divider circuit 222 generates a voltage V_{DIV225}, which is a divided voltage of a voltage between the high-side terminal TM_{H} and the low-side terminal TM_{L}. The voltage V_{DIV225} is equal to a voltage drop generated by the voltage dividing resistor 224. Therefore, the voltage V_{DIV225} is applied to the node 225.

A non-inverting input terminal of the amplifier 221 is connected to the node 225 and receives the voltage V_{DIV225}. An inverting input terminal and an output terminal of the amplifier 221 are connected to the node ND_{M1}, and therefore are connected to the node ND[1] via the node ND_{M1} and the middle terminal TM_{M}[1]. Therefore, a voltage at the inverting input terminal and the output terminal of the amplifier 221 is the middle voltage V_{MID}[1]. A positive power supply terminal and a negative power supply terminal of the amplifier 221 are connected to the nodes ND_{H} and ND_{L}, respectively, and the amplifier 221 operates based on a voltage of the positive power supply terminal (hence the input voltage V_{IN}) with a potential of the negative power supply terminal (hence the ground potential) as a reference. For this reason, a high-breakdown voltage amplifier having a breakdown voltage greater than the above-mentioned maximum input voltage V_{INMAX} (see FIG. 8) is used as the amplifier 221.

A resistance value ratio of the voltage dividing resistors 223 and 224 is set so that a resistance value R223 of the voltage dividing resistor 223 and a resistance value R224 of the voltage dividing resistor 224 are “R223:R224=1:2.” For this reason, when errors are ignored, “V_{DIV225}=2·V_{IN}/3” is established.

When “V_{DIV225}>V_{MID}[1]” is established, the amplifier 221 outputs a current (positive charges) from the output terminal of the amplifier 221 to the node ND[1] via the middle terminal TM_{M}[1], and this current output increases the middle voltage V_{MID}[1]. The increase in the middle voltage V_{MID}[1] results in a decrease in the voltage V_{C}[1] and an increase in the voltages V_{C}[2] and V_{C}[3]. The increase in the middle voltage V_{MID}[1] when “V_{DIV225}>V_{MID}[1]” holds reduces a difference between the voltage (2·V_{IN}/3) and the middle voltage V_{MID}[1]. Conversely, when “V_{DIV225}<V_{MID}[1]” is established, the amplifier 221 draws in a current (positive charges) from the node ND[1] via the middle terminal TM_{M}[1] toward the output terminal of the amplifier 221, and this current draw decreases the middle voltage V_{MID}[1]. The decrease in the middle voltage V_{MID}[1] results in an increase in the voltage V_{C}[1] and a decrease in the voltages V_{C}[2] and V_{C}[3]. The decrease in the middle voltage V_{MID}[1] when “V_{DIV225}<V_{MID}[1]” holds reduces a difference between the voltage (2·V_{IN}/3) and the middle voltage V_{MID}[1]. As described above, the amplifier 221 compares the voltage V_{DIV225} (i.e., the voltage (2·V_{IN}/3)), which is a first comparison voltage, with the middle voltage V_{MID}[1], which is a second comparison voltage, and generates a current according to a result of comparison between the node ND[1] and the middle terminal TM_{M}[1], thereby reducing the difference between the voltage (2·V_{IN}/3) and the middle voltage V_{MID}[1] (ideally, keeping the difference at zero).

A first end of the voltage dividing resistor 233 is connected to the node ND_{H}. A second end of the voltage dividing resistor 233 is connected to a first end of the voltage dividing resistor 234 at a node 235. A second end of the voltage dividing resistor 234 is connected to the node ND_{L}. The voltage divider circuit 232 generates a voltage V_{DIV235} which is a divided voltage of a voltage between the high-side terminal TM_{H} and the low-side terminal TM_{L}. The voltage V_{DIV235} is equal to a voltage drop generated by the voltage dividing resistor 234. Therefore, the voltage V_{DIV235} is applied to the node 235.

A non-inverting input terminal of the amplifier 231 is connected to the node 235 and receives the voltage V_{DIV235}. An inverting input terminal and an output terminal of the amplifier 231 are connected to the node ND_{M2}, and therefore are connected to the node ND[2] via the node ND_{M2} and the middle terminal TM_{M}[2]. Therefore, a voltage at the inverting input terminal and the output terminal of the amplifier 231 is the middle voltage V_{MID}[2]. A positive power supply terminal and a negative power supply terminal of the amplifier 231 are connected to the nodes ND_{H} and ND_{L}, respectively, and the amplifier 231 operates based on a voltage of the positive power supply terminal (hence the input voltage V_{IN}) with a potential of the negative power supply terminal (hence the ground potential) as a reference. For this reason, a high-breakdown voltage amplifier having a breakdown voltage greater than the above-mentioned maximum input voltage V_{INMAX} (see FIG. 8) is used as the amplifier 231.

A resistance value ratio of the voltage dividing resistors 233 and 234 is set so that a resistance value R233 of the voltage dividing resistor 233 and a resistance value R234 of the voltage dividing resistor 234 are “R233:R234=2:1.” Therefore, when errors are ignored, “V_{DIV235}=V_{IN}/3” is established.

When “V_{DIV235}>V_{MID}[2]” is established, the amplifier 231 outputs a current (positive charges) from the output terminal of the amplifier 231 to the node ND[2] via the middle terminal TM_{M}[2], and the output of this current increases the middle voltage V_{MID}[2]. The increase in the middle voltage V_{MID}[2] results in a decrease in the voltages V_{C}[1] and V_{C}[2] and an increase in the voltage V_{C}[3]. The increase in the middle voltage V_{MID}[2] when “V_{DIV235}>V_{MID}[2]” holds reduces a difference between the voltage (V_{IN}/3) and the middle voltage V_{MID}[2].

Conversely, when “V_{DIV235}<V_{MID}[2]” holds, the amplifier 231 draws in a current (positive charges) from the node ND[2] via the middle terminal TM_{M}[2] toward the output terminal of the amplifier 231, and this current draw reduces the middle voltage V_{MID}[2]. The decrease in the middle voltage V_{MID}[2] results in an increase in the voltages V_{C}[1] and V_{C}[2] and a decrease in the voltage V_{C}[3]. The decrease in the middle voltage V_{MID}[2] when “V_{DIV235}<V_{MID}[2]” holds reduces the difference between the voltage (V_{IN}/3) and the middle voltage V_{MID}[2]. As described above, the amplifier 231 compares the voltage V_{DIV235} (i.e., the voltage (V_{IN}/3)), which is a first comparison voltage, with the middle voltage V_{MID}[2], which is a second comparison voltage, and generates a current according to a result of comparison between the node ND[2] and the middle terminal TM_{M}[2], thereby reducing the difference between the voltage (V_{IN}/3) and the middle voltage V_{MID}[2] (ideally, keeping the difference at zero).

The amplifier 221 reduces the difference between the voltage (2·V_{IN}/3) and the middle voltage V_{MID}[1], and the amplifier 231 reduces the difference between the voltage (V_{IN}/3) and the middle voltage V_{MID}[2], so that differences among the voltages V_{C}[1], V_{C}[2], and V_{C}[3] are reduced, and ideally, the voltages V_{C}[1] to V_{C}[3] are all the same. The voltage regulating device 20b performs control to make the voltages V_{C}[1] to V_{C}[3] equal to one another even when there are differences in leakage current among the capacitors C[1] to C[3]. Thus, the capacitors C[1] to C[3] are suppressed from exceeding their breakdown voltage due to the differences in leakage current. In addition, since a voltage is equally applied to the capacitors C[1] to C[3], voltage dependency of the capacitance value is common among the capacitors C[1] to C[3].

### Example EX_B3

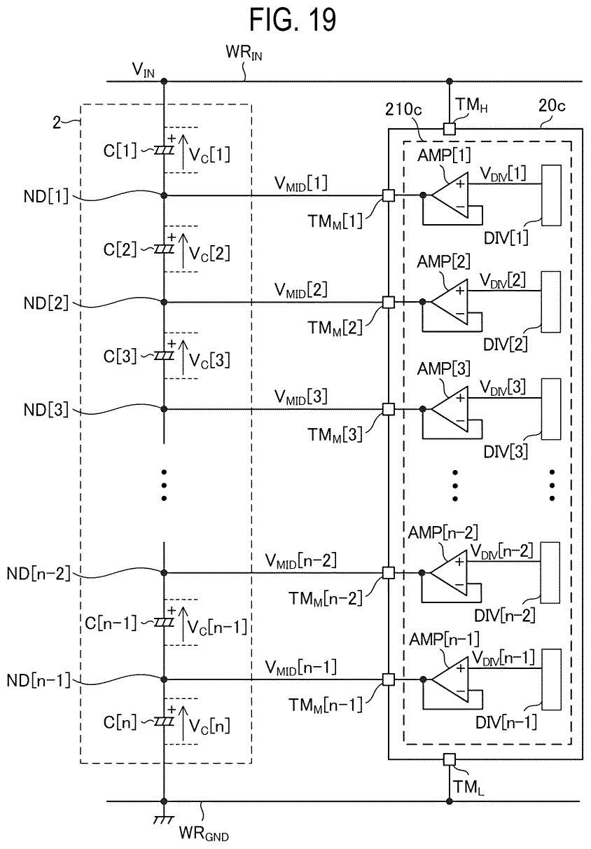

Example EX_B3 will be described. The techniques shown in Examples EX_B1 and EX_B2 can also be applied to the voltage regulating device 3 when “n≥4.” FIG. 19 shows a configuration of a voltage regulating device 20c, which is the voltage regulating device 3 in Example EX_B3. When “n=2,” the voltage regulating device 20c is the same as the voltage regulating device 20a in FIG. 17, and when “n=3,” the voltage regulating device 20c is the same as the voltage regulating device 20b in FIG. 18.

The voltage regulating device 20c includes a voltage leveling circuit 210c in addition to the high-side terminal TM_{H}, the low-side terminal TM_{L}, and the middle terminals TM_{M}[1] to TM_{M}[n−1]. The voltage regulating device 20c can be formed in the semiconductor device SD (see FIG. 11). In this case, the terminals TM_{H}, TM_{L}, and TM_{M}[1] to TM_{M}[n−1] are provided as external terminals in the semiconductor device SD, and a semiconductor chip on which the voltage leveling circuit 210c is integrated is accommodated in the housing CS. The voltage leveling circuit 210b includes amplifiers AMP[1] to AMP[n−1], which are operational amplifiers, and voltage divider circuits DIV[1] to DIV[n−1]. In the following description of Example EX_B3, i represents any natural number equal to or less than (n−1) unless otherwise specified.

Outside the voltage regulating device 20c, the high-side terminal TM_{H} is connected to the wiring WR_{IN}, and the low-side terminal TM_{L} is connected to the wiring WR_{GND}. Outside the voltage regulating device 20c, the middle terminal TM_{M}[i] is connected to the cathode of the capacitor C[i] and the anode of the capacitor C[i+1] via the node ND[i]. That is, the node ND[i] is located between the cathode of the capacitor C[i] and the anode of the capacitor C[i+1] and the middle terminal TM_{M}[i].

The voltage divider circuit DIV[i] is connected to the terminals TM_{H} and TM_{L}, and generates a voltage V_{DIV}[i], which is a divided voltage of a voltage between the terminals TM_{H} and TM_{L}. Therefore, voltages V_{DIV}[1] to V_{DIV}[n−1] are generated by the voltage divider circuits DIV[1] to DIV[n−1].

The voltage V_{DIV}[i] is supplied from the voltage divider circuit DIV[i] to a non-inverting input terminal of the amplifier AMP[i]. An inverting input terminal and an output terminal of the amplifier AMP[i] are connected to the middle terminal TM_{M}[i], and are connected to the node ND[i] via the middle terminal TM_{M}[i]. Therefore, a voltage at the inverting input terminal and the output terminal of the amplifier AMP[i] is the middle voltage V_{MID}[i]. A positive power supply terminal and a negative power supply terminal of the amplifier AMP[i] are connected to the terminals TM_{H} and TM_{L}, respectively, and the amplifier AMP[i] operates based on a voltage of the positive power supply terminal (hence the input voltage V_{IN}) with a potential of the negative power supply terminal (hence the ground potential) as a reference. For this reason, a high-breakdown voltage amplifier having a breakdown voltage greater than the above-mentioned maximum input voltage V_{INMAX} (see FIG. 8) is used as the amplifier AMP[i].

The voltage divider circuit DIV[i] is formed so that “V_{DIV}[i]=V_{IN}. (n−i)/n” is established. That is, a first comparison voltage in the amplifier AMP[i] is a product of the voltage (V_{IN}) of the high-side terminal TM_{H} as viewed from the potential of the low-side terminal TM_{L} and “(n−i)/n.” A second comparison voltage in the amplifier AMP[i] is the middle voltage V_{MID}[i] (the voltage of the middle terminal TM_{M}[i] as viewed from the potential of the low-side terminal TM_{L}).

When “V_{DIV}[i]>V_{MID}[i]” is established, the amplifier AMP[i] outputs a current (positive charges) from the output terminal of the amplifier AMP[i] via the middle terminal TM_{M}[i] toward the node ND[i], and this current output increases the middle voltage V_{MID}[i]. The increase in the middle voltage V_{MID}[i] results in a decrease in the voltages V_{C}[1] to V_{C}[i] and an increase in the voltages V_{C}[i+1] to V_{C}[n]. The increase in the middle voltage V_{MID}[i] when “V_{DIV}[i]>V_{MID}[i]” holds reduces a difference between the voltage V_{DIV}[i] and the middle voltage V_{MID}[i]. Conversely, when “V_{DIV}[i]<V_{MID}[i]” is established, the amplifier AMP[i] draws in a current (positive charges) from the node ND[i] via the middle terminal TM_{M}[i] toward the output terminal of the amplifier AMP[i], and this current draw decreases the middle voltage V_{MID}[i]. The decrease in the middle voltage V_{MID}[i] results in an increase in the voltages V_{C}[1] to V_{C}[i] and a decrease in the voltages V_{C}[i+1] to V_{C}[n]. The decrease in the middle voltage V_{MID}[i] when “V_{DIV}[i]<V_{MID}[i]” holds reduces the difference between the voltage V_{DIV}[i] and the middle voltage V_{MID}[i]. As described above, the amplifier AMP[i] compares the voltage V_{DIV}[i] (i.e., the voltage V_{IN}. (n−i)/n), which is a first comparison voltage, with the middle voltage V_{MID}[i], which is a second comparison voltage, and generates a current according to a result of comparison between the node ND[i] and the middle terminal TM_{M}[i], thereby reducing the difference between the voltage V_{DIV}[i] and the middle voltage V_{MID}[i] (ideally, keeping the difference at zero).

The amplifiers AMP[1] to AMP[n−1] reduce differences among the voltages V_{DIV}[i] and V_{MID}[i] for each integer i that satisfies “1≤i≤n−1,” thereby reducing differences among the voltages V_{C}[1] to V_{C}[n]. Ideally, the voltages V_{C}[1] to V_{C}[n] are all the same. The voltage regulating device 20c performs control to make the voltages V_{C}[1] to V_{C}[n] equal to one another even when there are differences in leakage current among the capacitors C[1] to C[n]. Thus, the capacitors C[1] to C[n] are suppressed from exceeding their breakdown voltage due to the differences in leakage current. In addition, since a voltage is equally applied to the capacitors C[1] to C[n], voltage dependency of the capacitance value is common among the capacitors C[1] to C[n].

### Example EX_C

Example EX_C will be described.

The types of channels of FETs (Field Effect Transistors) shown in the above-described embodiments are merely examples. Without departing from the spirit of the above, the type of channel of any FET may change between a P-channel type and an N-channel type.

Any of the transistors described above may be any type of transistor as long as it does not cause any problem. For example, any transistor described above as a MOSFET may be replaced with a junction FET, an insulated gate bipolar transistor (IGBT), or a bipolar transistor as long as it does not cause any problem. Any transistor has a first electrode, a second electrode, and a control electrode. In an FET, one of the first and second electrodes is a drain, the other of the first and second electrodes is a source, and the control electrode is a gate. In an IGBT, one of the first and second electrodes is a collector, the other of the first and second electrodes is an emitter, and the control electrode is a gate. In a bipolar transistor not belonging to the IGBT, one of the first and second electrodes is a collector, the other of the first and second electrodes is an emitter, and the control electrode is a base.

The embodiments of the present disclosure can be appropriately modified in various ways within the scope of the technical ideas shown in the claims. The above-described embodiments are merely examples of the embodiments of the present disclosure, and the meanings of the terms of the present disclosure or configuration requirements are not limited to those described in the above-described embodiments. The specific numerical values shown in the above description are merely examples, and it goes without saying that they can be changed to various numerical values.

### <<Supplementary Notes>>

Supplementary notes will be provided for the present disclosure in which specific configuration examples are shown in the above-described embodiments.

A voltage regulating device (see FIG. 1, FIG. 4, FIG. 7, FIG. 15, and the like) according to one aspect of the present disclosure is a voltage regulating device (3, 10a, 10b) connected to a series circuit of a plurality of electrolytic capacitors (C[1] to C[n]) provided between a ground wiring (WR_{GND}) and an input voltage wiring (WR_{IN}) to which an input voltage (V_{IN}) higher than a potential of the ground wiring is applied, and includes: a high-side terminal (TM_{H}) connected to the input voltage wiring; a low-side terminal (TM_{L}) connected to the ground wiring; a middle terminal (TM_{M}[i]) connected to a connection node between the plurality of electrolytic capacitors; and a voltage limiting circuit (20) configured to limit a voltage between the high-side terminal and the middle terminal to a high-side limit voltage (VH_{LIM}) or lower by controlling a high-side regulating current (I_{H}) between the high-side terminal and the middle terminal according to the voltage between the high-side terminal and the middle terminal, and configured to limit a voltage between the middle terminal and the low-side terminal to a low-side limit voltage (VL_{LIM}) or lower by controlling a low-side regulating current (I_{L}) between the middle terminal and the low-side terminal according to the voltage between the middle terminal and the low-side terminal (first configuration).

When the plurality of electrolytic capacitors is connected in series, there is a concern that excessive voltages may be applied to specific electrolytic capacitors due to differences in leakage current among the plurality of electrolytic capacitors. By using the voltage regulating device of the first configuration, voltages applied to the electrolytic capacitors can be limited to a desired limit voltage or lower against variations in leakage current, and therefore a system including the electrolytic capacitors can be operated safely.

In the voltage regulating device of the first configuration, the voltage limiting circuit may include: a high-side transistor (12H) interposed between the high-side terminal and the middle terminal; a high-side controller (11H) configured to control presence or absence and a magnitude of the high-side regulating current by controlling a gate voltage of the high-side transistor according to the voltage between the high-side terminal and the middle terminal, so that the voltage between the high-side terminal and the middle terminal is limited to the high-side limit voltage or lower; a low-side transistor (12L) interposed between the middle terminal and the low-side terminal; and a low-side controller (11L) configured to control presence or absence and a magnitude of the low-side regulating current by controlling a gate voltage of the low-side transistor according to the voltage between the middle terminal and the low-side terminal, so that the voltage between the middle terminal and the low-side terminal is limited to the low-side limit voltage or lower (second configuration).

In the voltage regulating device of the second configuration, the high-side controller may include: a high-side voltage divider circuit (112H) configured to generate a high-side divided voltage (V_{DIVH}) that is a divided voltage of the voltage between the high-side terminal and the middle terminal; and a high-side amplifier (111H) configured to control the presence or absence and the magnitude of the high-side regulating current by controlling the gate voltage of the high-side transistor according to a high-low relationship between the high-side divided voltage and a high-side reference voltage (V_{REFH}), and the low-side controller may include: a low-side voltage divider circuit (112L) configured to generate a low-side divided voltage (V_{DIVL}) that is a divided voltage of the voltage between the middle terminal and the low-side terminal; and a low-side amplifier (111L) configured to control the presence or absence and the magnitude of the low-side regulating current by controlling the gate voltage of the low-side transistor according to a high-low relationship between the low-side divided voltage and a low-side reference voltage (V_{REFL}) (third configuration).

In the voltage regulating device of the third configuration, the high-side amplifier may generate the high-side regulating current by cutting off the high-side transistor when the high-side divided voltage is lower than the high-side reference voltage, and by making the high-side transistor conductive when the high-side divided voltage is higher than the high-side reference voltage, so that the voltage between the high-side terminal and the middle terminal is limited to the high-side limit voltage or lower, and the low-side amplifier may generate the low-side regulating current by cutting off the low-side transistor when the low-side divided voltage is lower than the low-side reference voltage, and by making the low-side transistor conductive when the low-side divided voltage is higher than the low-side reference voltage, so that the voltage between the middle terminal and the low-side terminal is limited to the low-side limit voltage or lower (fourth configuration).

In the voltage regulating device of any one of the second to fourth configurations, a current limiting resistor (13H) is connected in series to the high-side transistor, and another current limiting resistor (13L) is connected in series to the low-side transistor (fifth configuration).

With this configuration, the high-side regulating current and the low-side regulating current are suppressed from becoming excessive, thereby protecting the voltage regulating device.

In the voltage regulating device of any of the first to fifth configurations, the plurality of electrolytic capacitors may include a first electrolytic capacitor (C[1]) and a second electrolytic capacitor (C[2]), which are connected in series with each other, an anode of the first electrolytic capacitor may be connected to the input voltage wiring, a cathode of the second electrolytic capacitor may be connected to the ground wiring, and a connection node (ND[1]) between a cathode of the first electrolytic capacitor and an anode of the second electrolytic capacitor may be connected to the middle terminal (TM [1]) (sixth configuration).

In the voltage regulating device of any of the first to fifth configurations, the plurality of electrolytic capacitors may include first to n-th electrolytic capacitors (C[1] to C[n]) connected in series with one another, the middle terminal may include first to (n−1)-th middle terminals (ND[1] to ND[n−1]), where n represents an integer equal to or greater than three, an anode of the first electrolytic capacitor may be connected to the input voltage wiring, a cathode of the n-th electrolytic capacitor may be connected to the ground wiring, a connection node (ND[i]) between a cathode of the i-th electrolytic capacitor and an anode of the (i+1)-th electrolytic capacitor may be connected to the i-th middle terminal (TM_{M}[i]), where i represents a natural number equal to or less than (n−1), the high-side regulating current may be a current between the high-side terminal and the first middle terminal, the low-side regulating current may be a current between the (n−1)-th middle terminal and the low-side terminal, the voltage limiting circuit may limit a voltage between the high-side terminal and the first middle terminal to the high-side limit voltage or lower by controlling the high-side regulating current according to the voltage between the high-side terminal and the first middle terminal, and limit a voltage between the (n−1)-th middle terminal and the low-side terminal to the low-side limit voltage or lower by controlling the low-side regulating current according to the voltage between the (n−1)-th middle terminal and the low-side terminal, and the voltage limiting circuit may limit a voltage between two adjacent middle terminals among the first to (n−1)-th middle terminals to a middle limit voltage (VM_{LIM}) or lower by controlling a middle regulating current (I_{M}) between the two adjacent middle terminals according to the voltage between the two adjacent middle terminals (seventh configuration).

In the voltage regulating device of any of the first to seventh configurations, the voltage regulating device may be formed by a semiconductor device (SD), which has a housing (CS) accommodating the voltage limiting circuit and a plurality of external terminals exposed from the housing (eighth configuration).

In the voltage regulating device of any of the first to seventh configurations, the voltage regulating device may be formed by a plurality of semiconductor devices, each having a housing and a plurality of external terminals exposed from the housing, and the voltage limiting circuit may be accommodated in a distributed manner in the plurality of housings (ninth configuration).

A charge storage system according to one aspect of the present disclosure includes: the voltage regulating device of any one of the first to ninth configurations; and the plurality of electrolytic capacitors (tenth configuration).

A voltage regulating device (see FIG. 1, FIG. 4, and FIG. 17 to FIG. 19) according to another aspect of the present disclosure is a voltage regulating device (3, 20a, 20b, 20c) connected to a series circuit of a plurality of electrolytic capacitors (C[1] to C[n]) provided between a ground wiring (WR_{GND}) and an input voltage wiring (WR_{IN}) to which an input voltage (V_{IN}) higher than a potential of the ground wiring is applied, and includes: a high-side terminal (TM_{H}) connected to the input voltage wiring; a low-side terminal (TM_{L}) connected to the ground wiring; a middle terminal (TM_{M}[i]) connected to a connection node between the plurality of electrolytic capacitors; and a voltage leveling circuit (210a, 210b, 210c) configured to reduce a difference between an electrode-to-electrode voltage (V_{C}[1]) of a first electrolytic capacitor, which is included in the plurality of electrolytic capacitors, and an electrode-to-electrode voltage (V_{C}[2]) of a second electrolytic capacitor, which is included in the plurality of electrolytic capacitors, by controlling a current between the connection node and the middle terminal based on each of voltages of the high-side terminal and the middle terminal as viewed from a potential of the low-side terminal (eleventh configuration).

When the plurality of electrolytic capacitors are connected in series, there is a concern that excessive voltages may be applied to specific electrolytic capacitors due to differences in leakage current among the plurality of electrolytic capacitors. By using the voltage regulating device of the eleventh configuration, voltages applied to the plurality of electrolytic capacitors can be leveled against variations in leakage current, and therefore a system including the electrolytic capacitors can be operated safely.

In the voltage regulating device of the eleventh configuration, the series circuit of the plurality of electrolytic capacitors may be a series circuit of the first electrolytic capacitor (C[1]) and the second electrolytic capacitor (C[2]), an anode of the first electrolytic capacitor may be connected to the input voltage wiring, a cathode of the second electrolytic capacitor may be connected to the ground wiring, a connection node (ND[1]) between a cathode of the first electrolytic capacitor and an anode of the second electrolytic capacitor may be connected to the middle terminal, the voltage leveling circuit may include an amplifier (211) configured to compare a first comparison voltage (V_{DIV215}, V_{DIV}[1]) and a second comparison voltage (V_{MID}[1]) to generate a current between the connection node and the middle terminal according to a comparison result, and reduce the difference between the electrode-to-electrode voltage (V_{C}[1]) of the first electrolytic capacitor and the electrode-to-electrode voltage (V_{C}[2]) of the second electrolytic capacitor by the current generated by the amplifier, the first comparison voltage may half the voltage of the high-side terminal as viewed from the potential of the low-side terminal, and the second comparison voltage may be the voltage of the middle terminal as viewed from the potential of the low-side terminal (twelfth configuration).

In the voltage regulating device of the twelfth configuration, when the first comparison voltage is higher than the second comparison voltage, the amplifier may decrease the electrode-to-electrode voltage of the first electrolytic capacitor and increase the electrode-to-electrode voltage of the second electrolytic capacitor by outputting a current from the middle terminal toward the connection node, and, when the first comparison voltage is lower than the second comparison voltage, the amplifier may increase the electrode-to-electrode voltage of the first electrolytic capacitor and decrease the electrode-to-electrode voltage of the second electrolytic capacitor by drawing in a current from the connection node via the middle terminal (thirteenth configuration).

In the voltage regulating device of the eleventh configuration, the plurality of electrolytic capacitors may include first to n-th electrolytic capacitors (C[1] to C[n]) connected in series with one another, the middle terminal may include first to (n−1)-th middle terminals (TM_{M}[1] to TM_{M}[n−1]), where n represents an integer equal to or greater than three, an anode of the first electrolytic capacitor may be connected to the input voltage wiring, a cathode of the n-th electrolytic capacitor may be connected to the ground wiring, first to (n−1)-th connection nodes (ND[1] to ND[n−1]) may be formed in the series circuit of the plurality of electrolytic capacitors, an i-th connection node may be a connection node between a cathode of the i-th electrolytic capacitor and an anode of the (i+1)-th electrolytic capacitor and connected to am i-th middle terminal, where i represents a natural number equal to or less than (n−1), the voltage leveling circuit may include first to (n−1)-th amplifiers (AMP[1] to AMP[n−1]), output terminals of the first to (n−1)-th amplifiers may be connected to the first to (n−1)-th middle terminals, respectively, an i-th amplifier may compare a first comparison voltage (V_{DIV}[i]) and a second comparison voltage (V_{MID}[i]) to generate a current between an i-th connection node and an i-th middle terminal according to a comparison result, the voltage leveling circuit may reduce differences among electrode-to-electrode voltages (V_{C}[1] to V_{C}[n]) of the first to n-th electrolytic capacitors by the current generated by each amplifier, the first comparison voltage in the i-th amplifier may be a product of the voltage of the high-side terminal seen from the potential of the low-side terminal and (n−i)/n, and the second comparison voltage in the i-th amplifier may be a voltage of the i-th middle terminal seen from the potential of the low-side terminal (fourteenth configuration).

In the voltage regulating device of the fourteenth configuration, when the first comparison voltage in the i-th amplifier is higher than the second comparison voltage in the i-th amplifier, the i-th amplifier may decrease each of electrode-to-electrode voltages of the first to i-th electrolytic capacitors and increase each of electrode-to electrode voltages of the (i+1)-th to n-th electrolytic capacitors by outputting a current from the i-th middle terminal toward the i-th connection node, and, when the first comparison voltage in the i-th amplifier is lower than the second comparison voltage in the i-th amplifier, the i-th amplifier may increase each of the electrode-to-electrode voltages of the first to i-th electrolytic capacitors and decrease each of the electrode-to electrode voltages of the (i+1)-th to n-th electrolytic capacitors by drawing in a current from the i-th connection node via the i-th middle terminal (fifteenth configuration).

A charge storage system according to another aspect of the present disclosure includes: the voltage regulating device of any one of the eleventh to fifteenth configurations; and the plurality of electrolytic capacitors (sixteenth configuration).

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A voltage regulating device connected to a series circuit of a plurality of electrolytic capacitors provided between a ground wiring and an input voltage wiring to which an input voltage higher than a potential of the ground wiring is applied, comprising:
a high-side terminal connected to the input voltage wiring;
a low-side terminal connected to the ground wiring;
a middle terminal connected to a connection node between the plurality of electrolytic capacitors; and
a voltage limiting circuit configured to limit a voltage between the high-side terminal and the middle terminal to a high-side limit voltage or lower by controlling a high-side regulating current between the high-side terminal and the middle terminal according to the voltage between the high-side terminal and the middle terminal, and configured to limit a voltage between the middle terminal and the low-side terminal to a low-side limit voltage or lower by controlling a low-side regulating current between the middle terminal and the low-side terminal according to the voltage between the middle terminal and the low-side terminal.

2. The voltage regulating device of claim 1, wherein the voltage limiting circuit includes:
a high-side transistor interposed between the high-side terminal and the middle terminal;
a high-side controller configured to control presence or absence and a magnitude of the high-side regulating current by controlling a gate voltage of the high-side transistor according to the voltage between the high-side terminal and the middle terminal, so that the voltage between the high-side terminal and the middle terminal is limited to the high-side limit voltage or lower;
a low-side transistor interposed between the middle terminal and the low-side terminal; and
a low-side controller configured to control presence or absence and a magnitude of the low-side regulating current by controlling a gate voltage of the low-side transistor according to the voltage between the middle terminal and the low-side terminal, so that the voltage between the middle terminal and the low-side terminal is limited to the low-side limit voltage or lower.

3. The voltage regulating device of claim 2,
wherein the high-side controller includes:
a high-side voltage divider circuit configured to generate a high-side divided voltage that is a divided voltage of the voltage between the high-side terminal and the middle terminal; and
a high-side amplifier configured to control the presence or absence and the magnitude of the high-side regulating current by controlling the gate voltage of the high-side transistor according to a high-low relationship between the high-side divided voltage and a high-side reference voltage, and
wherein the low-side controller includes:
a low-side voltage divider circuit configured to generate a low-side divided voltage that is a divided voltage of the voltage between the middle terminal and the low-side terminal; and
a low-side amplifier configured to control the presence or absence and the magnitude of the low-side regulating current by controlling the gate voltage of the low-side transistor according to a high-low relationship between the low-side divided voltage and a low-side reference voltage.

4. The voltage regulating device of claim 3, wherein the high-side amplifier generates the high-side regulating current by cutting off the high-side transistor when the high-side divided voltage is lower than the high-side reference voltage, and by making the high-side transistor conductive when the high-side divided voltage is higher than the high-side reference voltage, so that the voltage between the high-side terminal and the middle terminal is limited to the high-side limit voltage or lower, and
wherein the low-side amplifier generates the low-side regulating current by cutting off the low-side transistor when the low-side divided voltage is lower than the low-side reference voltage, and by making the low-side transistor conductive when the low-side divided voltage is higher than the low-side reference voltage, so that the voltage between the middle terminal and the low-side terminal is limited to the low-side limit voltage or lower.

5. The voltage regulating device of claim 2, wherein a current limiting resistor is connected in series to the high-side transistor, and another current limiting resistor is connected in series to the low-side transistor.

6. The voltage regulating device of claim 1, wherein the plurality of electrolytic capacitors includes a first electrolytic capacitor and a second electrolytic capacitor, which are connected in series with each other, and
wherein an anode of the first electrolytic capacitor is connected to the input voltage wiring, a cathode of the second electrolytic capacitor is connected to the ground wiring, and a connection node between a cathode of the first electrolytic capacitor and an anode of the second electrolytic capacitor is connected to the middle terminal.

7. The voltage regulating device of claim 1, wherein the plurality of electrolytic capacitors includes first to n-th electrolytic capacitors connected in series with one another, and the middle terminal includes first to (n−1)-th middle terminals, where n represents an integer equal to or greater than three,
wherein an anode of the first electrolytic capacitor is connected to the input voltage wiring, and a cathode of the n-th electrolytic capacitor is connected to the ground wiring,
wherein a connection node between a cathode of an i-th electrolytic capacitor and an anode of an (i+1)-th electrolytic capacitor is connected to an i-th middle terminal, where i represents a natural number equal to or less than (n−1),
wherein the high-side regulating current is a current between the high-side terminal and the first middle terminal, and the low-side regulating current is a current between the (n−1)-th middle terminal and the low-side terminal,
wherein the voltage limiting circuit limits a voltage between the high-side terminal and the first middle terminal to the high-side limit voltage or lower by controlling the high-side regulating current according to the voltage between the high-side terminal and the first middle terminal, and limits a voltage between the (n−1)-th middle terminal and the low-side terminal to the low-side limit voltage or lower by controlling the low-side regulating current according to the voltage between the (n−1)-th middle terminal and the low-side terminal, and
wherein the voltage limiting circuit limits a voltage between two adjacent middle terminals among the first to (n−1)-th middle terminals to a middle limit voltage or lower by controlling a middle regulating current between the two adjacent middle terminals according to the voltage between the two adjacent middle terminals.

8. The voltage regulating device of claim 1, wherein the voltage regulating device is formed by a semiconductor device, which has a housing accommodating the voltage limiting circuit and a plurality of external terminals exposed from the housing.

9. The voltage regulating device of claim 1, wherein the voltage regulating device is formed by a plurality of semiconductor devices, each having a housing and a plurality of external terminals exposed from the housing, and
wherein the voltage limiting circuit is accommodated in a distributed manner in the plurality of housings.

10. A charge storage system comprising:
the voltage regulating device of claim 1; and
the plurality of electrolytic capacitors.

11. A voltage regulating device connected to a series circuit of a plurality of electrolytic capacitors provided between a ground wiring and an input voltage wiring to which an input voltage higher than a potential of the ground wiring is applied, comprising:
a high-side terminal connected to the input voltage wiring;
a low-side terminal connected to the ground wiring;
a middle terminal connected to a connection node between the plurality of electrolytic capacitors; and
a voltage leveling circuit configured to reduce a difference between an electrode-to-electrode voltage of a first electrolytic capacitor, which is included in the plurality of electrolytic capacitors, and an electrode-to-electrode voltage of a second electrolytic capacitor, which is included in the plurality of electrolytic capacitors, by controlling a current between the connection node and the middle terminal based on each of voltages of the high-side terminal and the middle terminal as viewed from a potential of the low-side terminal.

12. The voltage regulating device of claim 11, wherein the series circuit of the plurality of electrolytic capacitors is a series circuit of the first electrolytic capacitor and the second electrolytic capacitor,
wherein an anode of the first electrolytic capacitor is connected to the input voltage wiring, a cathode of the second electrolytic capacitor is connected to the ground wiring, and a connection node between a cathode of the first electrolytic capacitor and an anode of the second electrolytic capacitor is connected to the middle terminal,
wherein the voltage leveling circuit includes an amplifier configured to compare a first comparison voltage and a second comparison voltage to generate a current between the connection node and the middle terminal according to a comparison result, and reduces the difference between the electrode-to-electrode voltage of the first electrolytic capacitor and the electrode-to-electrode voltage of the second electrolytic capacitor by the current generated by the amplifier, and
wherein the first comparison voltage is half the voltage of the high-side terminal as viewed from the potential of the low-side terminal, and the second comparison voltage is the voltage of the middle terminal as viewed from the potential of the low-side terminal.

13. The voltage regulating device of claim 12, wherein when the first comparison voltage is higher than the second comparison voltage, the amplifier decreases the electrode-to-electrode voltage of the first electrolytic capacitor and increases the electrode-to-electrode voltage of the second electrolytic capacitor by outputting a current from the middle terminal toward the connection node, and
wherein when the first comparison voltage is lower than the second comparison voltage, the amplifier increases the electrode-to-electrode voltage of the first electrolytic capacitor and decreases the electrode-to-electrode voltage of the second electrolytic capacitor by drawing in a current from the connection node via the middle terminal.

14. The voltage regulating device of claim 11, wherein the plurality of electrolytic capacitors includes first to n-th electrolytic capacitors connected in series with one another, and the middle terminal includes first to (n−1)-th middle terminals, where n represents an integer equal to or greater than three,
wherein an anode of the first electrolytic capacitor is connected to the input voltage wiring, and a cathode of the n-th electrolytic capacitor is connected to the ground wiring,
wherein first to (n−1)-th connection nodes are formed in the series circuit of the plurality of electrolytic capacitors, and an i-th connection node is a connection node between a cathode of an i-th electrolytic capacitor and an anode of an (i+1)-th electrolytic capacitor and is connected to an i-th middle terminal, where i represents a natural number equal to or less than (n−1),
wherein the voltage leveling circuit includes first to (n−1)-th amplifiers,
wherein output terminals of the first to (n−1)-th amplifiers are connected to the first to (n−1)-th middle terminals, respectively,
wherein an i-th amplifier compares a first comparison voltage and a second comparison voltage to generate a current between an i-th connection node and an i-th middle terminal according to a comparison result, and the voltage leveling circuit reduces differences among electrode-to-electrode voltages of the first to n-th electrolytic capacitors by the current generated by each amplifier, and
wherein the first comparison voltage in the i-th amplifier is a product of the voltage of the high-side terminal seen from the potential of the low-side terminal and (n−i)/n, and the second comparison voltage in the i-th amplifier is a voltage of the i-th middle terminal seen from the potential of the low-side terminal.

15. The voltage regulating device of claim 14, wherein, when the first comparison voltage in the i-th amplifier is higher than the second comparison voltage in the i-th amplifier, the i-th amplifier decreases each of electrode-to-electrode voltages of the first to i-th electrolytic capacitors and increases each of electrode-to electrode voltages of the (i+1)-th to n-th electrolytic capacitors by outputting a current from the i-th middle terminal toward the i-th connection node, and,
wherein when the first comparison voltage in the i-th amplifier is lower than the second comparison voltage in the i-th amplifier, the i-th amplifier increases each of the electrode-to-electrode voltages of the first to i-th electrolytic capacitors and decreases each of the electrode-to electrode voltages of the (i+1)-th to n-th electrolytic capacitors by drawing in a current from the i-th connection node via the i-th middle terminal.

16. A charge storage system comprising:
the voltage regulating device of claim 11; and
the plurality of electrolytic capacitors.
